(19) United States
(12) Patent Application Publication
(10) Pub. No.: US 2004/0002892 A1
(43) Pub. Date: Jan. 1, 2004

(54) Portal for global portfolio management system method & apparatus

(76) Inventors: Martin Gluck, Munich (DE); Norbert Mohr, Furth (DE); Susanne Kloth, Saal a.d. Donau (DE)

Correspondence Address: WHITE & CASE LLP, PATENT DEPARTMENT, 1155 AVENUE OF THE AMERICAS, NEW YORK, NY, 10036, US

(21) Appl. No.: 10/370,961

(22) Filed: Feb. 20, 2003

Related U.S. Application Data
(60) Provisional application No. 60/365,894, filed on Mar. 20, 2002.

(51) Int. Cl. G06F 17/60

(52) U.S. Cl. 705/10; 705/36

(57) ABSTRACT

A portfolio creation and management tool creates and manages a portfolio of intellectual property assets of a global entity having sub-entities located in various localities around the world. The sub-entities have a legal relationship to the entity, by contract or by law of a an internationally recognized jurisdiction. A network connection connects a sub-entity of the global entity residing in more than one jurisdiction. A portfolio application residing on a central server downloads from the network, stores and maintains data representative of the intellectual property assets of the global entity, including data internal to at least one sub-entity. The portfolio application provides segments that combine one or more intellectual property assets into a category that has a market relevance to the global entity and provides objects that represent assets of an external entity. The portfolio application allocates the segments to at least one portfolio and an evaluation tool provides a selectable value that indicates a worth to each asset. An analysis tool of the portfolio application provides analysis of the portfolio by organizing at least one of the segments and objects in a manner that demonstrates a comparison amongst the segments and, respectively, the objects.

### PRIORITY

This application claims priority to the U.S. Provisional Application filed Mar. 20, 2002 (serial No. 60/365,894).

### BACKGROUND

1. Field of the Invention

The invention relates to providing and managing a portfolio and, more particularly, to a system, method and apparatus for providing and managing an intellectual property portfolio and for providing therefor a portal through which the portfolio is reported and improved. The invention has, in particular, in mind to provide for a computer application and/or internet application and interface therefor to provide portfolio creation and analysis.

2. Related Art

Today more than ever, the world is becoming more interconnected. Of course, there have long since been international corporations, but today the corporations are becoming truly global. That is, rather than having branches in different countries, the corporation of today is an organization of constituents from different areas of the world that contribute and interact with each other toward the common goal of success of the company.

As these entities become more integrated, we are beginning to witness the invention of global solutions to problems that literally never have been faced before. Part of what made this possible, and along with it the challenges of an ever-unfolding global drama, is the Internet. Through which, people are capable of connecting to each other and communicating as never before. The Internet is not merely an extension of the computer. Nor is it an advanced telephone. It is a new communication forum that offers new and exciting ways in which people, and corporations, are able to meet and exchange ideas and information, virtually, world wide.

As alluded to above, the Internet has not been without its challenges. Never before had corporations needed to deal with the myriad of issues arising from the world wide web, ranging anywhere from administrative issues of organizing and reorganizing corporate structure to real legal issues that must be addressed before conducting business on the web. Miscalculation of organizing web strategies have thrown businesses into bankruptcy. Copyright issues on the Internet have confounded the entire entertainment industry, But, that is merely the beginning and legal issues, such as taxation, importation and every area of law, will play a unique role on the Internet.

We will not delve into the unfathomable issues regarding the Internet here. Suffice to say that the issues have never before been faced and truly require a new wave of technology and strategy to deal with them. The reason why they have never before been dealt with is because the Internet has never before been in existence. It is until lately that these issues have ever arised. And, it is simplistic to say that these issues are merely extensions of old principles long well known. This is clearly not the case. The old principles have proven inadequate to deal with the new issues of the Internet. For this reason, parliaments of the world are beginning now to redraft major legislations to deal with the unique issues of the Internet, for example, the United States Congress' amendment of the trademark laws to take into account Domain Name ownership and cybersquatting.

This invention deals with the problem of integrating a worldwide portfolio of a global entity. In particular, the invention deals with the problem of organizing a portfolio and managing the same for yielding strategies to deal with, among other things, competitors. More exactly, the invention is directed to managing intangible assets, such as intellectual property, including copyrights, trademarks, trade secrets and patents. In addition, the invention provides analysis tools for examining and evaluating the portfolio and dealing with, and comparing, competitors assets and strategies concerned. The invention has in mind the ability to direct the business of the global entity through the analysis of world-wide assets for any cross-section of technical field or market.

In addition, the invention provides a portal through which various sub-entities are capable of interfacing and interacting with the portfolio, or sub-sets, thereof. The portal according to the invention has the capability to not only report information regarding the portfolio, but also to allow the participants to analyze and improve upon the portfolio. For that matter, the portal tool allows the full integration of participants world-wide, including analysis and input therefrom.

In the past, there has been provided data processing tools that track assets of an entity. However, these have traditionally been docketing systems that merely track the status of an asset and perhaps offer timing alerts to alert the owner, or representative, to maintain or file documents relating to the asset. These are merely docketing systems and they fall considerably short of a portfolio tool that assembles a portfolio that can be viewed and analyzed. Nor do such docketing systems provide tools for analyzing the portfolio.

In addition, there has been no adequate analyzing tools provided by such systems. Docketing systems are merely dumb applications that report text based data. These systems have not provided the tools, such as graphic tables and charts, that analyze the portfolio.

Moreover, there was a motivation to keep such archaic docketing systems dumb and not allow them to provide such analyses. It was feared, perhaps naively, that such systems would cause an error and, therefore, open the representative of the entity to be exposed to liability. Further, it was feared that insurance companies who provide insurance to such representatives would not insure activity regarding such an autonomous system. Therefore, there was a built in prejudice that ensured that no portfolio function was provided by the prior docketing systems.

Nor have such docketing systems provided an interface, or portal, through which the entity is capable to interact and provide participation in the improvement of the portfolio. Again, the prior docketing systems were designed to be dumb. Besides, it was discouraged to allow the entity to manipulate the portfolio. It was considered, perhaps myopically, that the entity for its own good should not be involved with the management of its docket.

Further, the old docketing systems did not take advantage of the capabilities of the Internet. Perhaps, such systems had linked through the Internet. But, never before has there been the capability to interact and manipulate a portfolio using the full extent of the world wide web. There has not previously been the full integration of world wide participation of inputting knowledge and data regarding a portfolio. Information from all organs of an entity brought to bear on improving a portfolio has never before been undertaken.

Still another problem of the old systems was that they were not integrated with the internal administration of the entity. Typically, the docketing systems were maintained by representatives of the entity or by an accounting department. Thus, the old systems were not capable of integrating technical information known by the entity that may be relevant to the portfolio. Further, the old systems were not capable of integrating administrative information or procedures that may be unique to the entity. Further, any information regarding the assets of the entity, and particularly of the competitor, were incorporated from public resources. This is particularly true of patent assets, were it is the standard to incorporate data from publications of patent applications, such as supplied by Derwent. Problematically, the data did not always match the actual asset owned by the entity and, further, did not always represent the most up to date version or status of the asset.

Furthermore, the old systems were not capable of establishing a portal that is capable of supplying information of the portfolio in a confidential manner. In many conglomerate companies today, there is the necessity to maintain confidentiality. Particularly with regards to legal assets, such as patents, information regarding the portfolio must be maintained confidential. This is not only to protect the trade secrets of the company, but also to maintain the patentability of a corresponding invention, as some jurisdictions require the invention be maintained confidential. This is particularly problematic today with the Internet and Internet related projects, as many entities today are forming joint ventures which share information. It is necessary, therefore, that the portal knows how to maintain confidentiality as between various entities whom may share access to the portal tool.

The prior systems simply did not reflect the business concerns of the entity. Administrative decisions and statuses, such as whether to pursue an asset, or when an asset was ready for application of right, such as when a patent application is ready for filing, were not taken into account. The strategy of the managers of the entity, which factored such parameters as market size, conditions and prospect for corresponding product, and technical considerations were also not taken into account.

What is needed that was clearly lacking is portfolio management that manages the portfolio of a global entity. One that utilizes the Internet to its full potential to bring together information from all organs of an enterprise. A tool is needed to provide competitive analysis. An invention is needed that incorporates information at the client end and has a capability to process the analyses according to administrative data. What is needed is a portfolio management tool that takes into account the business of the entity, including technical information. A tool is needed to allow sub-entities to review and improve the portfolio and in a way that maintains proper confidentiality of the asset. What is needed is the novel portfolio management and portal system, method and apparatus of the present invention.

### SUMMARY AND OBJECTS OF THE INVENTION

It is an object of the invention to provide portfolio management.

It is another object of the invention to provide to provide portfolio management for intellectual property assets.

It is another object of the invention to provide portfolio management for a world wide entity.

It is another object of the invention to provide portfolio management utilizing Web technology.

It is another object of the invention to provide portfolio analysis.

It is another object of the invention to provide tools for portfolio analysis.

It is another object of the invention to provide a portfolio that integrates information direct from the entity.

It is another object of the invention to provide a portfolio that is linked to the Intranet of the entity.

It is another object of the invention to provide portfolio analysis of a competitors portfolio.

It is another object of the invention to provide a comparison of the portfolio to a competitors portfolio.

It is another object of the invention to provide a portal for the interfacing and integration of sub-entities input.

It is another object of the invention to provide a portal that allows the sub-entities to improve the portfolio and the analysis.

It is another object of the invention to provide a portal in a confidential manner that maintains the confidentiality of the asset.

It is another object of the invention to provide a portfolio that takes into account the business of the entity.

In accordance with these and other foregoing objectives, the present invention provides portfolio creation and management for creating and managing a portfolio of intellectual property assets of a global entity having sub-entities located in various localities around the world. The sub-entities have a legal relationship to the entity, by contract or by law of a an internationally recognized jurisdiction. A network connection connects a sub-entity of the global entity residing in more than one jurisdiction. A portfolio application residing on a central server downloads from the network, stores and maintains data representative of the intellectual property assets of the global entity, including data internal to at least one sub-entity. The portfolio application provides segments that combine one or more intellectual property assets into a category that has a market relevance to the global entity and provides objects that represent assets of an external entity. The portfolio application allocates the segments to at least one portfolio and an evaluation tool provides a selectable value that indicates a worth to each asset. An analysis tool of the portfolio application provides analysis of the portfolio by organizing at least one of the segments and objects in a manner that demonstrates a comparison amongst the segments and, respectively, the objects.

In the present invention, a portfolio regards a super set of folders that each relate to an asset of the entity and the corresponding evaluation and analysis data regarding the portfolio.

In the present invention, an entity is defined as having a plurality of sub-entities that are associated by a legal instrument, such as a conglomerate or company or joint venture, whose sub-entities exist in different localities in the world. Sub-entities have a corporate legal relationship to the entity, by contract or by law of an internationally recognized jurisdiction. For example, a business unit or subsidiary of a parent company has a legal relationship under corporate law in accordance with articles of incorporation submitted by the company. A joint-venture firm has a corporate relationship that, albeit more ephemeral than a business unit, is fixed by law under contract. A majority share holding is a company whose parent owns a majority of the shares and sits on the board of directors and acts to control the company.

An asset is defined as an intangible good owned by the entity, or having a right to own the good, which tends to establish a competitive advantage for the entity in a market. The assets may be intellectual property rights, including rights in applications therefor. However, the assets may be other intangibles, such as business practice or administrative best practice or accounting sheets securities.

Administrative decisions are considered by the invention to be the business workings of the entity that involve the management of the asset. These may include decisions to proceed or maintain an asset, shares of an asset allocated, cost centers of a sub-entity or shared costs, etc. It is generally considered that time deadlines relating to said administrative decisions are includes, but legal time deadlines, i.e., those mandated by law or a government agency, are not part of the definition of administrative decisions.

A time deadline herein is defined as a legal limit that is mandated by law or government agency, not an internal deadline relating to an administrative function.

In contrast with a decentralized system, such as offered by client/server technology, the present invention is a centralized approach. The disadvantage of a decentralized system is that the application and data are located on the user's machine. For one thing, decentralized systems require installation of the application on each machine. This is not only wasteful of computer services, but, more importantly, does not allow for the fluid expansion of users, which is required in a large global entity, such as a corporate conglomerate. Another disadvantage is that it is not capable of providing a world-wide network of contributing users that allows for cross-sharing of patents and analysis of information from one technical field to another.

The present application is a web application. This means that both the application and data are centrally stored on a server. This has the advantage of requiring no installation, which, for a global entity is important for fluidity and expansion of activity. For another thing, the program/data updates are carried out more simply by changing the version at the server. Not to mention that data is centrally available and is, therefore, analyzed in a manner which can overlap individual projects.

The applicant of the present invention has previously experimented with earlier attempts to provide a solution to the problem of portfolio creation in general. The early attempts of portfolio creation did not address the unique issues of global integration, particularly regarding the Internet. It shall also be noted that the earlier attempts did not provide portfolio creation or analysis of other intellectual properties, including trademarks, trade secrets and copyright. A more serious defect of the earlier work was that it failed to provide competitive analysis. Further, the earlier work did not have anything to do with providing a portal for interfacing the creator, or entity, with information concerning the asset to assist in the development of the portfolio and analysis. It is believed to the best of knowledge that the earlier attempt was created under confidentiality and was maintained as internal.

### BRIEF DESCRIPTION OF THE DRAWINGS

FIG. 1 is a system architecture of the present invention;

FIG. 2 is a process overview of the present invention;

FIGS. 3a-3e show screen shots for searching, assigning and evaluating assets according to the present invention;

FIGS. 4a,b show a block diagram and segment list, respectively, for segmenting the assets according to the present invention;

FIGS. 5a,b show screen shots for adding segments and creating evaluation schemes of the present invention;

FIGS. 6a-c show an example of assigning segments, objects and evaluation of the present invention;

FIGS. 7a-c show reports and graphic charts of the present invention; and

FIGS. 8a-e show screen shots of the portal of the present invention.

### DETAILED DESCRIPTION OF THE PREFERRED EMBODIMENTS

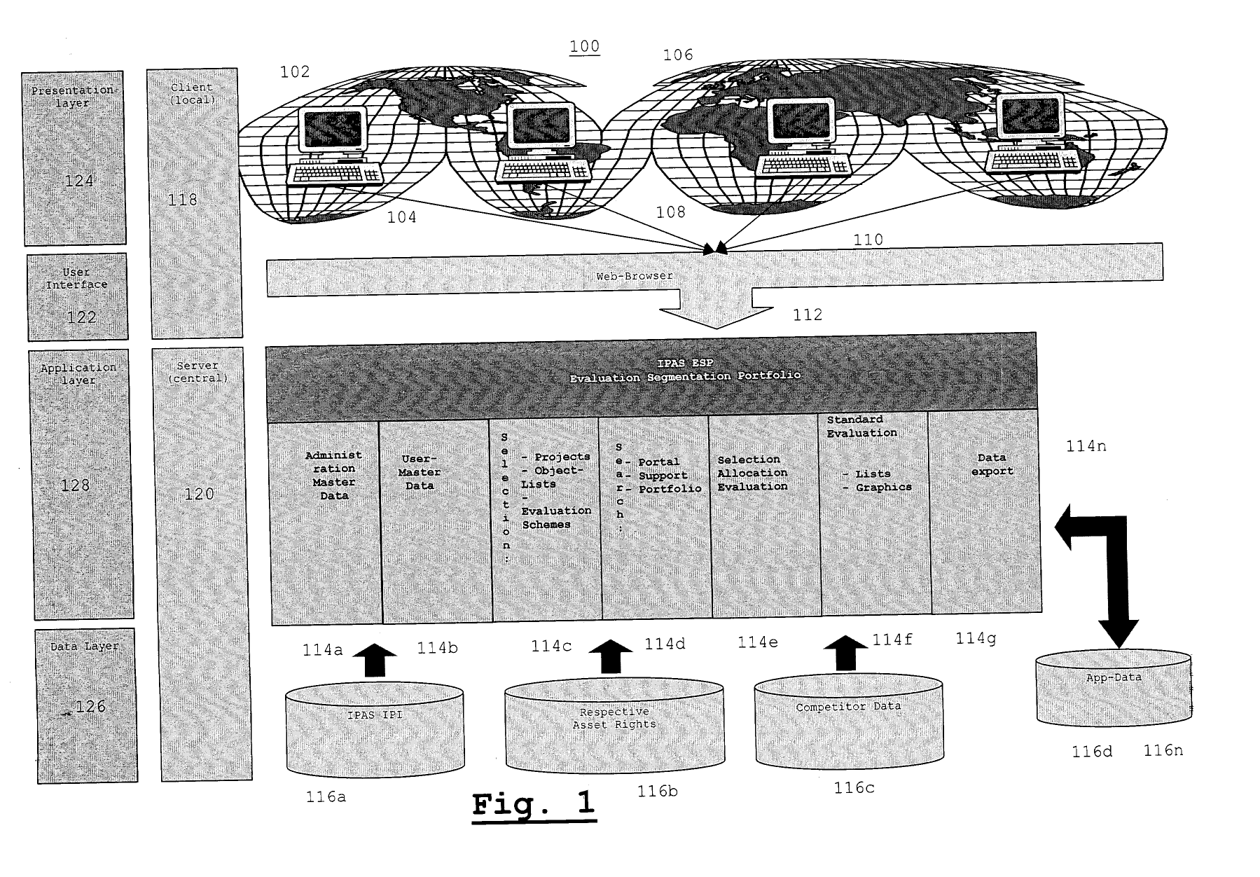

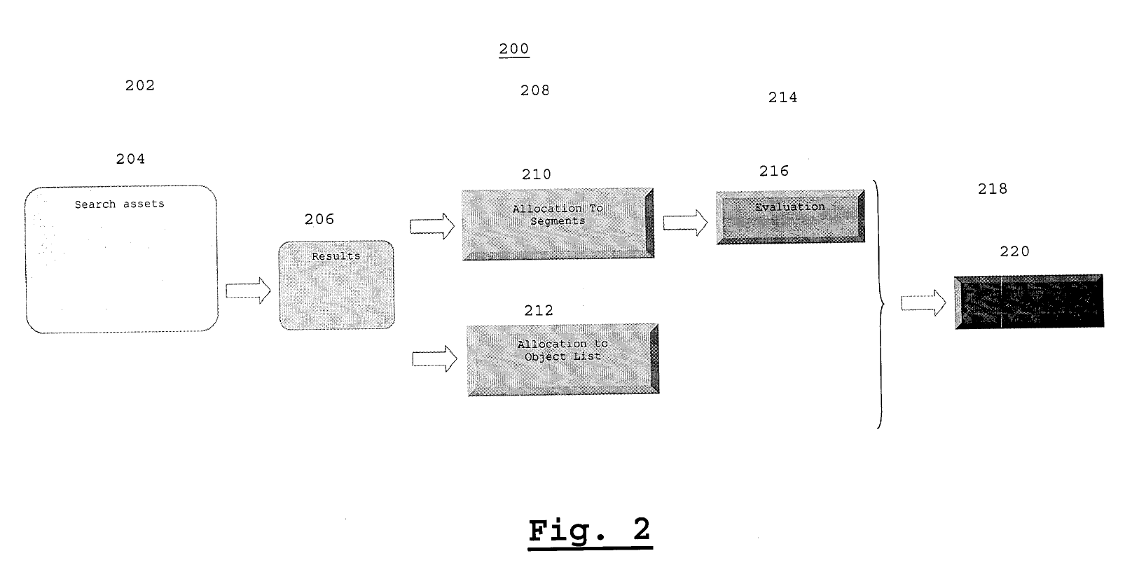

The invention will now be described with reference to FIG. 1, wherein there is shown a system diagram 100 of the novel invention. There is shown, in the entire world 102, one or more sub-entities 104 that comprise a global, or common, entity, such as a global corporation or conglomerate. The sub-entities 104 may be, for example, business units of the company or subsidiaries. The sub-entities 104 sit in various parts 106, or countries, of the world 102 and are connected by way of an Online Network, such as the Internet or World-Wide Web (WWW) 108, by way of an interface or web-browser 110. An application 112 orchestrates the activities of the sub-entities 104 directed toward providing a portfolio for assets and the management thereof and assembles and organizes and manages therefor applications, programmable objects and databases 114a-114n utilizing information from data sources 116a-116n.

Administration master data and applications 114a are assembled that relate to the administrative decisions of the asset and will be used to reflect, in part, the business considerations of the entity as applied to the analysis of the portfolio. User applications or master data 114b are assembled that relate to the information regarding the user that, for example, are used to maintain the confidential nature of assets as between users. Selections or settings 114c that set up the parameters for a portfolio, assignment of assets to a segment, which will be discussed later, and an evaluation scheme are assembled. Applications are provided for the creation of the portfolio, amongst other portfolios for example. The parameters of the segments and the settings for evaluation are set accordingly. A search engine is provided 114d that provides searching and organization of data regarding the assets from a plurality of sources including both internal business and external, or published, data. Action applications 114e allow the user to select the portfolio desired, assign the assets of the portfolio or competitors portfolio to a segment and evaluation the assets. Analysis tools and applications 114f are provided including reports and graphical tools. There is also provided data export tools 114g for providing external interface with other tools.

The invention accesses a user database 116a that provides information about the sub-entities, or users. This includes information about the share of costs to develop an asset or the share of interest in the asset by a sub-entity, or user. The invention further accesses information 116b regarding the assets themselves, such as all legal information relating to a patent application or granted patent or maintenance fees and scheduling. Further, competitor data 116c sources are accessed that include both internal and external. In addition, there is provided access to a database 116d that stores the portfolio data.

The invention shown in FIG. 1 is arranged in terms of a client side 118 and a server side 120. The client side includes the sub-entities 104 of the entity who access and connect from different localities in the world 102 through the Internet 108 using a web browser or other interface 110. The client side for this purpose includes a user interface 122 that allows the users of the various sub-entities 104 to interface with the portfolio and a presentations layer 124 that provides the applications, or instantiations thereof, for presenting the portfolio and analysis. On the server side 120, there is provided a data layer 126 which provides the databases and applications for accessing the data bases and an applications layer 128 for providing the applications, or instantiations thereof, for the general portfolio and analysis. One skilled in the art of application layer programming will understand readily how the details of the layers and their appropriate interfaces are constructed without undue experimentation.

Several things will be noted from FIG. 1. The present invention provides portfolio creation and management and, more particularly, incorporates all of the information from all organs of a global entity by taking advantage of the full capabilities of the Internet. It will be particularly appreciated from the FIG. 1 that the invention provides a centralized approach for integrating all of the information from the various sub-entities 104 world-wide 102. This not only provides centralized data, it maintains the integrity of the data as the data is not accessible directly by the sub-entities.

In addition, the invention is directed to the business needs of the entity. It allows for the expansions and, for that matter, the contraction of the entity, because the sub-entities only need access to the Internet, and any updates may be provided at a central location. Thus, sub-entities, such as a business unit, that is no longer associated with the entity, such as by sale to another company, is simply disallowed access to the central sever. With the access to both external and internal information, such as from within business units of the company, the invention provides for an up to date and more relevant portfolio and analysis.

In operation, a sub-entity, such as a joint venture partner in China, accesses a portal through her web browser. Contemporaneously, or not, another sub-entity, such as the co-joint venture partner in Germany, accesses a portal through his web browser. By way of example, the joint venture partner in Germany is the research and development business unit of a global international conglomerate comprising a parent company and subsidiaries that are held publicly and some which are held by majority share. Notably, not all the sub-entities in the example have, nor should have, access to all confidential information of the conglomerate. For example, the joint venture partner in China may be involved in only a joint venture, according to a joint venture agreement, for supplying supply chain management software to the R&D business unit. Thus, the partner in China is only allowed to access the portfolio regarding the joint venture.

To continue, the parent conglomerate desires that the patent portfolio for supply chain management software be updated and improved. For this, the inventions arising out of the joint venture are applied for patent in several countries, including the United States, China and Germany, for example. The basic information regarding the asset itself is recorded by the invention.

Let's further assume that the assets are owned 50% by the R&D business unit and 50% by the parent conglomerate and 0% by the Chinese venture partner. Further, it is stated in the agreement that the conglomerate will pay for all of the costs associated According to the joint venture agreement, but that the R&D business unit will spend man hours in the preparation of the patent applications. Further, there are meetings held at the R&D business unit amongst the managers of the venture to decide whether to proceed with an asset. The invention records such kind of administrative data.

Further assume that the inventions may be interested to other business units who may benefit from cross sharing the information arising from the joint venture. Cross sharing data and linking to other markets of interest to other sub-entities is recorded.

According to the invention, the Chinese firm is given no access to the portions of the portfolio database 116b which do not concern it in order to maintain confidentiality of patentable inventions and trade secrets. Perhaps, the Chinese firm is allowed to add information regarding its findings in the course of venture or specialized knowledge of local markets in China. The R&D business unit, which is a subsidiary of the conglomerate, would have access to all information, but for the purpose of this venture updates the portfolio database 116d on the preparation and filing of applications for patent. According to the invention, the confidentiality of inventions are preserved so that the inventions may be developed into patent assets.

Along with this information, the share of interest is stored as between the R&D business unit and the parent in the user database 116a. In countries where inventors are reimbursed for their inventions, the invention further allows for the input of interest as between inventors in this database 116a. In addition, the costs shared are input as well into the portfolio application in 116a.

Additional information which may be known to the R&D business unit, such as specialized understanding of the market reaction to a product related to a patent is recorded in database 116c. Similarly, competitor information regarding the portfolio for supply chain management software is store in database 116c. As well, information is input and stored in 116a that indicates which other sub-entities of the conglomerate may be interested in the product. The other sub-entities, having access to the portfolio, are prompted thereby and inspect and report their own interest in the asset. In turn, the other sub-entities may request to share in the patent asset in return for paying a part of the R&D business units costs. Combined together, the information from a plurality of sub-entities having each their unique perspective on the assets provides the foundation of a portfolio that offers a truly global perspective, the likes of which has never before been achieved.

The information described above is downloaded from the client side 118 by way of the sub-entity portal through the Internet to the centralized portfolio application on the server side 120 of the present invention. The invention then collates and files the information into the databases 116a-n as already described.

The various applications 114a-n selectively upload the data to create the portfolios and provide analysis therefor. The manner and operation of these applications 114a-n will now be discussed. By way of introduction, the overall operation 200 of the invention will be presented as illustrated by the flow diagram of FIG. 2.

As shown in the FIG. 2, the overall flow diagram begins with a selection of relevant assets, i.e., patents in step 202, in which the assets which relate to the requested portfolio are selected. In more detail, the assets in the database 116b are searched according to step 204 and the results are provided to the user in step 206. It will be at once appreciated that a particular patent may relate to several portfolios. It is the invention that decides where and how to apply the asset to a particular portfolio. These settings are stored in the portfolio database 116d.

In any event, the invention then provides segmentation of the assets in the selected portfolio in step 208 in which there is provided assignment of assets of the entity in step 210 and assignment of assets of a competitor in step 212. Evaluation is provided according to the step 218 in which the assets assigned to segments of a particular portfolio are given values according to a valuation scheme in step 216. The invention, as will be explained in more detail, assigns a coordinator for the evaluation of a particular asset, in order to prevent conflicting valuations from being entered by various sub-entities. Rather, it is provided in the invention that the coordinator valuate the asset according to information given to the coordinator via, for example, an asset steering committee. In step 208, the portfolio is analyzed in which reports are provided in step 220.

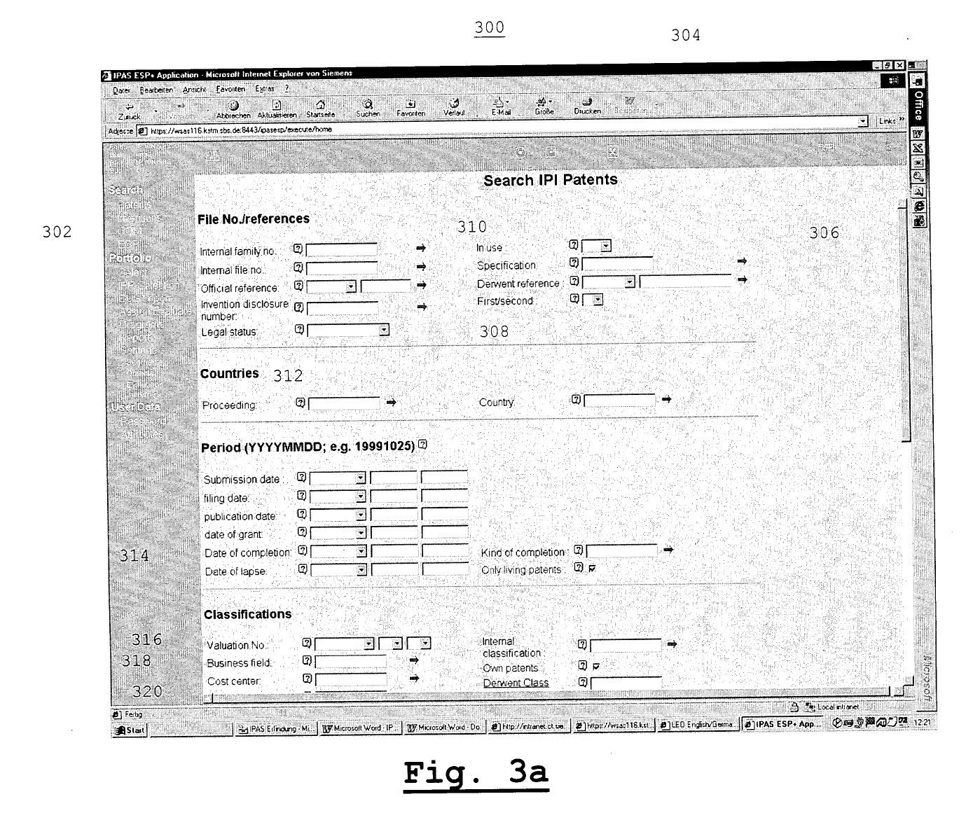

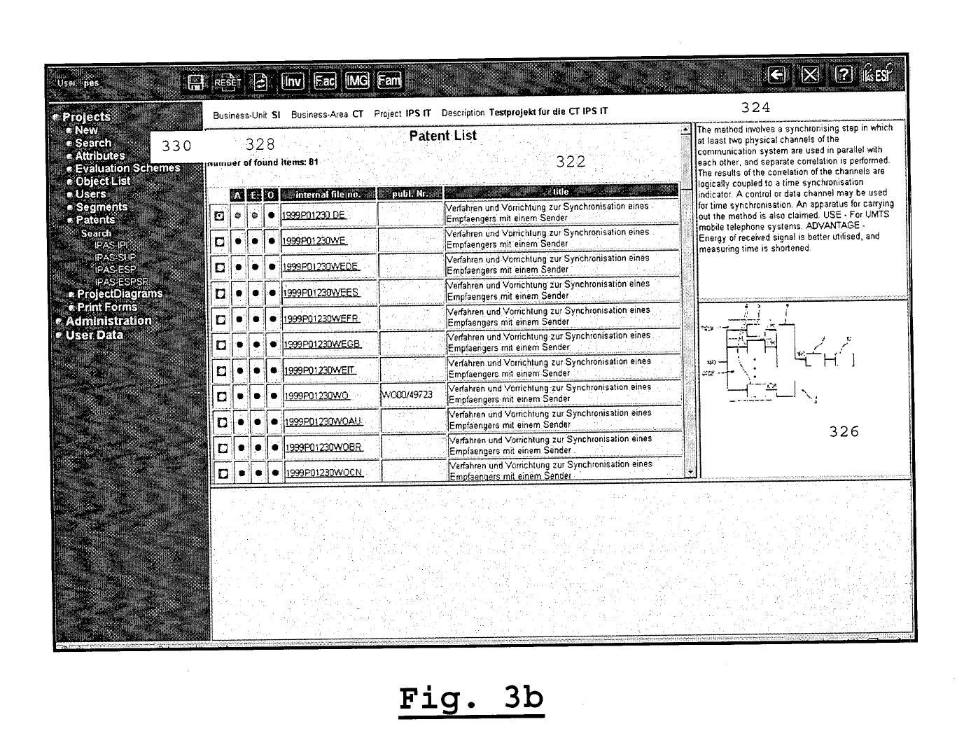

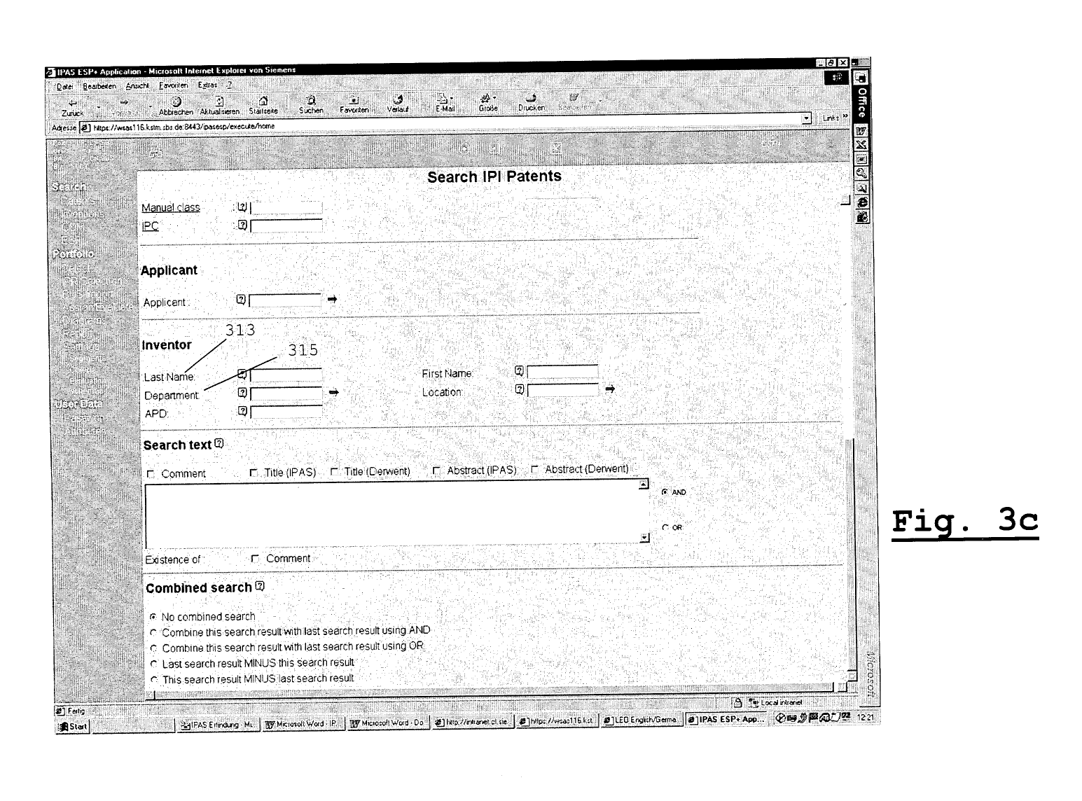

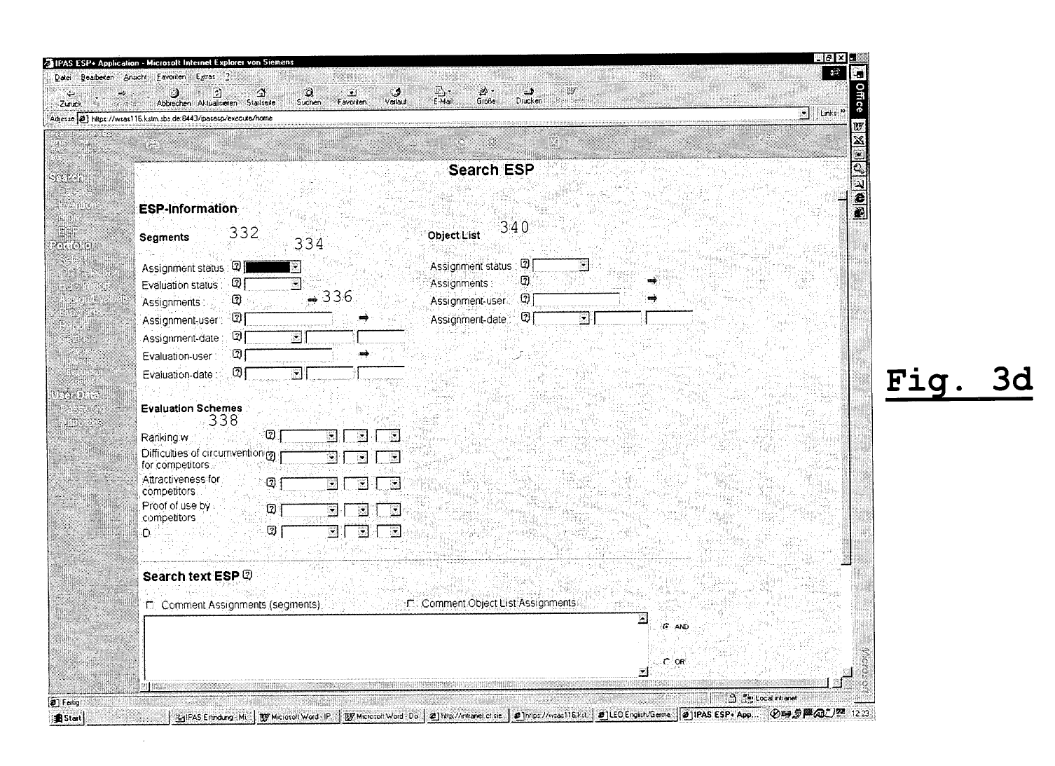

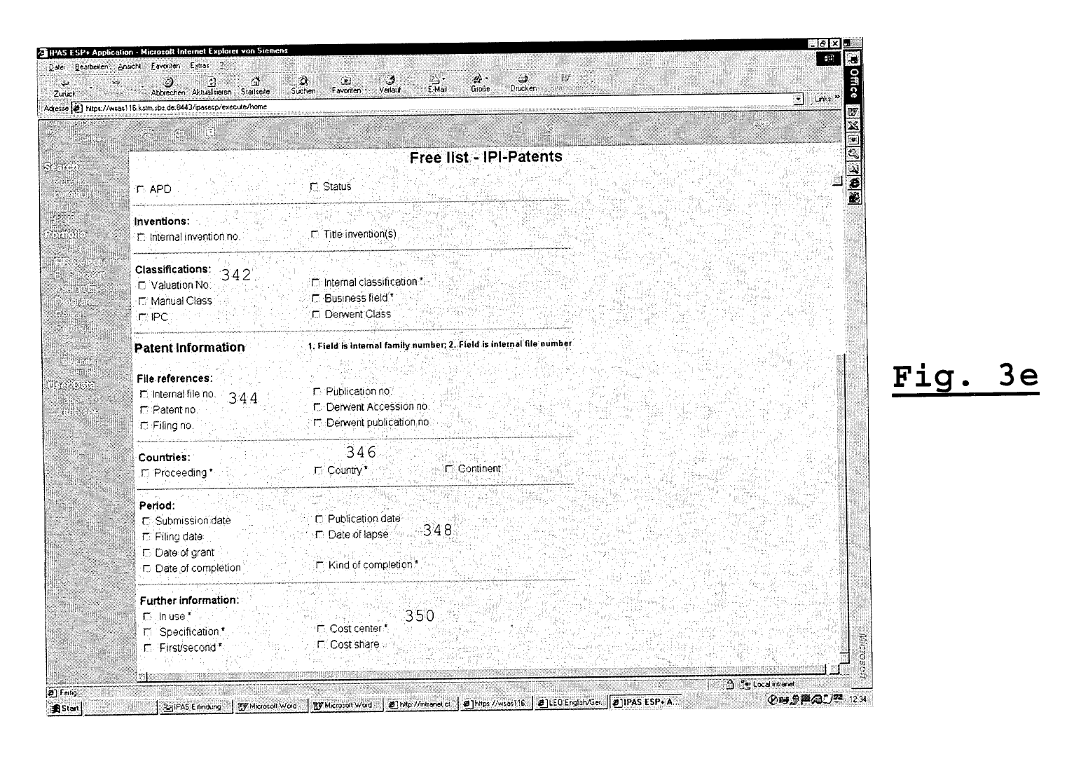

Now, with reference to FIGS. 3a-e, the selection of assets of step 202 (FIG. 2) will now be described in more detail. In FIG. 3a, there is shown generally one graphical user interface (GUI) 300 provided by the present invention including an area for selecting applications 302, which are in this example, hypertext links to the applications. Here, there is generally shown the applications divided into three categories, namely, search, portfolio and user data applications. The search applications retrieve the assets according to user-specified features of an asset. The portfolio applications select a particular portfolio amongst others, define segments and evaluation schemes, assign the assets to segments defined and valuate the assets according to the scheme set up and creating the portfolio. They also display the portfolio and generate graphic representations of the portfolio. The portfolio applications further provide analytical tools, including analysis of the entity (or competitor) portfolio using graphics and comparisons to competitor data and/or portfolios. There is further provided a command bar 304 where user commands, such as initiate search, save and help buttons that link to the corresponding command are provided. There is further provided a user input dialog box 306 where the user, i.e., sub-entity, enters parameters for requesting asset information or for valuating an asset, such as segmentation information, evaluation value for an asset or competitor information.

The GUI in FIG. 3 shows the search dialog box of the invention, in which the sub-entity enters search criteria for assets of interest to the sub-entity. When the sub-entity wishes to create a new portfolio, for example, the user enters a criteria that reflects the feature sought in the assets. Of course, the assets may be searched according to the standard asset identification information, such as a patent application file number or filing date. It shall be particularly noted that the invention not only provides for official identification, such as a patent application serial number, but also on internal identifiers. Moreover, there is provided the ability to search the published databases, such as Derwent 308, according to published identifiers. This feature is not merely convenient, but allows the entity to search both internal and external data sources to accumulate assets therefrom and attain a complete and true picture of the portfolio from a world wide perspective and not merely on internal information.

In addition to searching assets according to the identification information, for example, of a say a patent, it shall be noted from the figure that there is provided the capability to search for assets based on business concerns. In particular, note that the assets are to be searched according to whether the asset is in use by the entity (or competitor) 310. Whether or not an asset is used is not normally provided in the asset information, such as with intellectual property assets. This information is given from the market, such as by the business units of the entity. With such information, the invention provides a more accurate picture of the portfolio, whereas a portfolio based merely on accumulation of assets in, for example, a particular technology is misleading.

Another search criteria allows the assets to be searched dependent on the country 312 which the asset relates. In patents, for example, this may be where the patent application was filed. It will be instantly appreciated that this information provides a truly global outlook to the resulting portfolio. With which, there is provided a portfolio that takes into account the assets wold wide. In addition, it will be appreciated that this is also of interest from a business strategy standpoint. Businesses are more interested in analyzing the big picture, rather than focussing a one particular market in the world.

As mentioned, the invention also searches assets according to a date stamp, such as a filing date or grant date of a patent application. For the business concern, there is further provided administrative information not available on the face of a patent, such as date of completion of the patent application. This allows the entity to analyze, for example, how quickly the asset was developed from invention to application and gives the entity the capability to adjust preparation times, for example, to increase efforts for more important assets and decrease them for less important ones. The feature may also be utilized to demonstrate the efficiency of asset preparation and handling.

Further administration data is tabulated for retrieving assets. These include such classification as a valuation number 316, a business field 318 or cost center 320, for example. The valuation number, as explained later, is the value assigned to the worth of the asset. Searching assets according to the worth is useful, for example, to generate a portfolio of high ranking assets. Of course, these high ranking assets would differ from entity to entity. The business field provides that the assets are searchable according to an associated business field, such as a particular technology. The benefit here, for example, would be that the entity can generate a portfolio for a particular targeted market. The cost center criteria allows the user to search according to the entity or sub-entity who funds the asset. Such a search would be useful, for example, for separating the assets according to business unit which would tend to show, among other things, productiveness in attaining assets per business unit.

Another noteworthy search criteria is the ability to search according to inventor 312. This allows the entity to discern, for example, which inventors are the most inventive. In addition, there is further provided the ability to search according to the inventor's department within her business unit. This would indicate the departments success in attaining assets. With which, a business would be able to generate a network that shows how well, for example, its different departments are acquiring assets.

It is also worthy of explanation that the invention provides for the searching of both internal and external information, such as Abstract information. It has often been found that the information internal to an entity differs from that publicly known. With this invention, it is provided to search the internal and external records and compare the acquity of the external records. This gives the entity the opportunity to correct the public record, or vice versa, if there is inconsistency. With this function, the entity has the ability to discover, and take subsequent action, to correct public perception of the entity's assets.

It will be useful to consider here an example of the operation. Given that the entity or sub-entity desires to construct a portfolio, the user first selects a search criteria. In this example, the company desires to compare the inventiveness of business units in Germany as opposed to the U.S. Furthermore, the entity would like to know which departments in each country are the most productive. They would also like to see how much they are spending in each department and, by the way, would like to award the most inventive employees who are outstanding in inventing important products for the company. Further, the company wants to compare the results to its main rival in the telecommunications sector in the U.S. And, it wants to have all these statistics in a convenient chart for display in a board meeting the next day.

The foregoing is possible with the present invention. In order to create the portfolio therefor, the user enters the countries Germany and U.S. in the country prompt in order to target these two countries. In the date of completion prompt, the company enters, for example, dates corresponding to the previous year for relevance. In the business field, the company enters telecommunications, since this is the business sector they are interested in and enter valuations corresponding to fair to excellent to extract the inventions that are important to the company. Additionally, there may be entered a valuation range in the in-use prompt to retrieve those inventions that are embodied as products by the company. Further, the departments in the telecommunications business unit which are of interest for the board meeting are entered. The search is executed each time for different entities, by inputting the ownership entity in the Applicant field and the competitor name thereafter.

The invention returns results according to step 206 (FIG. 2) in the form of a hit list 322 as shown in FIG. 3b. In addition, the invention provides, in the same layout, adjacent to the hit list, additional information that is useful for analysis of the asset. These include, for example, the shown abstract 324 and the significant FIG. 326. Other identifying information, such as the internal reference number or publication number may be provided. There is further provided an analysis and evaluation button list 328A, E, O (Asset, Evaluation, Object) for the analysis of each asset in the hit list and evaluation. Further there may be a selector button 330 for selecting the particular asset to be displayed. The buttons 328 are provided to change colors when the selected asset corresponding thereto is already assigned, evaluated or related to an object. This will be described later. Suffice to say that the information regarding the assets are searched amongst the databases 16a-16n and uploaded to the user having the requested characteristics. Namely, telecommunications patent applications for the U.S. and Germany business units in the designated departments that are valuable to the company and are sorted according to inventor. The results are provided for both the entity and the competitor.

The invention provides additional search engines. There is provided, for example, the search engine for searching information that is internal to the entity as shown in FIG. 3d. As shown, there is provided search criteria regarding the administration of the assets. This may include the status of the assignment of the asset 332, which indicates to which segment, if any, the asset is assigned. Also, the status of the evaluation of the asset 334 is searchable, which indicates to what evaluation value the asset to be searched is set. Search criteria regarding the details of the assignment and evaluation 336. This may include the user that performed the assignment and the date. Similarly, the user and date of evaluation are searchable.

Further, evaluation schemes are searchable 338. These may include the overall ranking of the asset. But, may also include more detailed market information, such as the difficulty of circumventing a patent, which is useful for determining the license value of a patent. There is also searchable in the figure, the attractiveness for competitors to the product relating to the asset, which is useful for determining the worth of the related product. Another factor which assists in determining the worth of a patent is the ease of which it is possible to prove use of the patent by a competitor.

The invention also offers a free-list mask as shown in FIG. 3e, which allows the user to select how she wants the information delivered. Each asset, according to the invention, is stored in the database along with all of its characteristics. However, the user may not wish to know all of the details thereof. In the free-list, the user is given the ability to select which characteristics of the asset are displayed in the hit list. In addition to the normal features of the invention, such as internal invention or title, there is provided additional display settings. In the classifications setting, a valuation number, which shows the value of the respective asset may be displayed. There is also a business field classification which may be selected for display. In the patent information field 344, the user has the option to display the asset according to internal or external reference numbers, which is convenient for determining the corresponding published reference number. There is also the ability to display the country or continent to which the assets apply, to produce regional information in the country field 346. Various periods are displayable 348, including notably the date of completion. In addition, the kind of completion, such as decision to complete by abandonment because of lack of interest or lackluster market outlook, is possible. Further information, such as the costs, share of costs for producing the asset or whether or not the asset is in-use is selectively displayed.

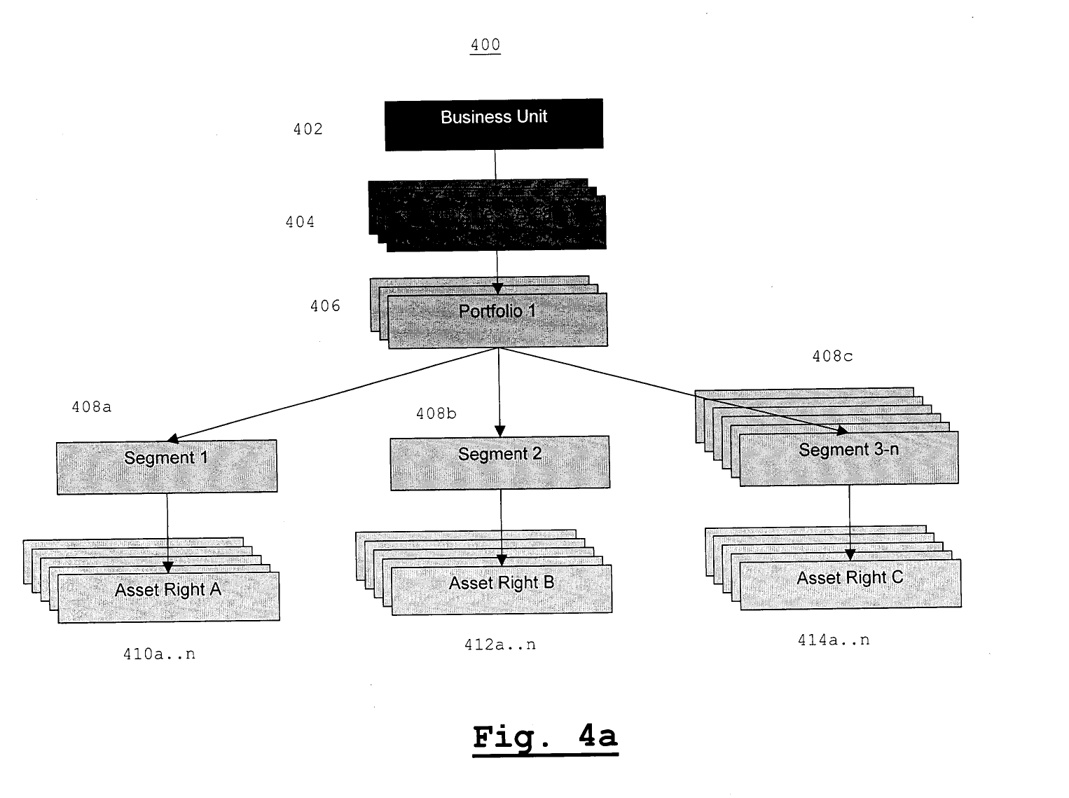

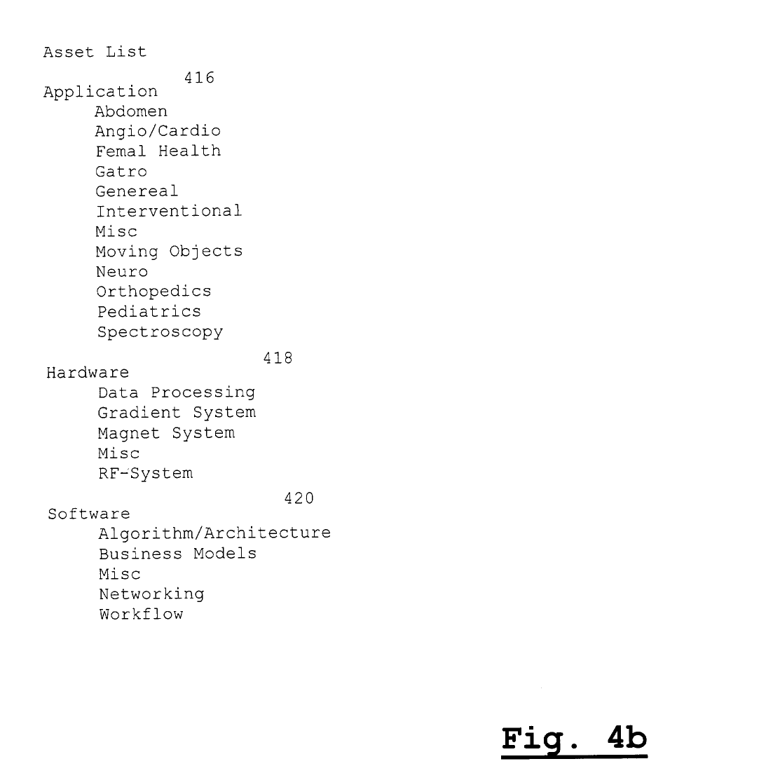

In accordance with step 208 (FIG. 2), the invention provides for segmentation of the assets. According to our example above, the invention provides a hit list (FIG. 3b) of our search. Now, with respect to FIG. 4a, there is shown an exemplary hierarchical layout 400 of the manner in which the invention segments the assets. The user first assigns selects a business unit 402 to create the portfolio, according to the above, in our example telecommunications business unit. The user further selects the business area 404, according to the above, in our example further assume that the selected business is mobile phone technology. The user is a business manager who creates a portfolio 406 for the board meeting in our example with reference to FIG. 3a and she names the portfolio Comparison of U.S. and German Telecommunications Business of Mobile Phone Market Assets to Competitor, for example. Then, the user further desires to segment the mobile phone market into segments. These may correspond to market segments. For example, segment 1 408a is assigned to ergonomic design patents, segment 2 408b is assigned to call center switching and segment 3 408c is assigned to cell phone hand-shaking standards.

Patents and applications fulfilling the criteria set forth above, namely U.S. and German filed for telecommunications that have a predetermined value to the company that relate to ergonomic designs for mobile phones are assigned to the segment 408a as assets 410a . . . n. Similarly, patents and applications relating to call center switching are assigned to segment 408b as assets 412a . . . n. Patents and applications for standards relating to protocols are assigned to segment 408c as assets 414a . . . n. Of course, any number of segments may be assigned. As well, the assets may be either patents or applications, or any intellectual property asset for that matter.

The invention also provides predetermined segments that are categorized according to business field. The invention has within its scope selecting and providing in advance the segments for a particular industry. In one aspect, this may be achieved by following a published classification system, such as the US or International patent classification system. As shown in FIG. 4b, there is a custom tailored segment list that is predetermined for specific markets. Here, for example, there are main categories relating to medical inventions, including applications for medical devices and processes 416, hardware for medical systems 418 and software for medical systems 420. Within the main categories, there are custom tailored subcategories that were determined through analyzing a specific business market which segments were relevant to the industry. In the invention, the user may develop this custom tailored segment list with the assistance of his world-wide partners.

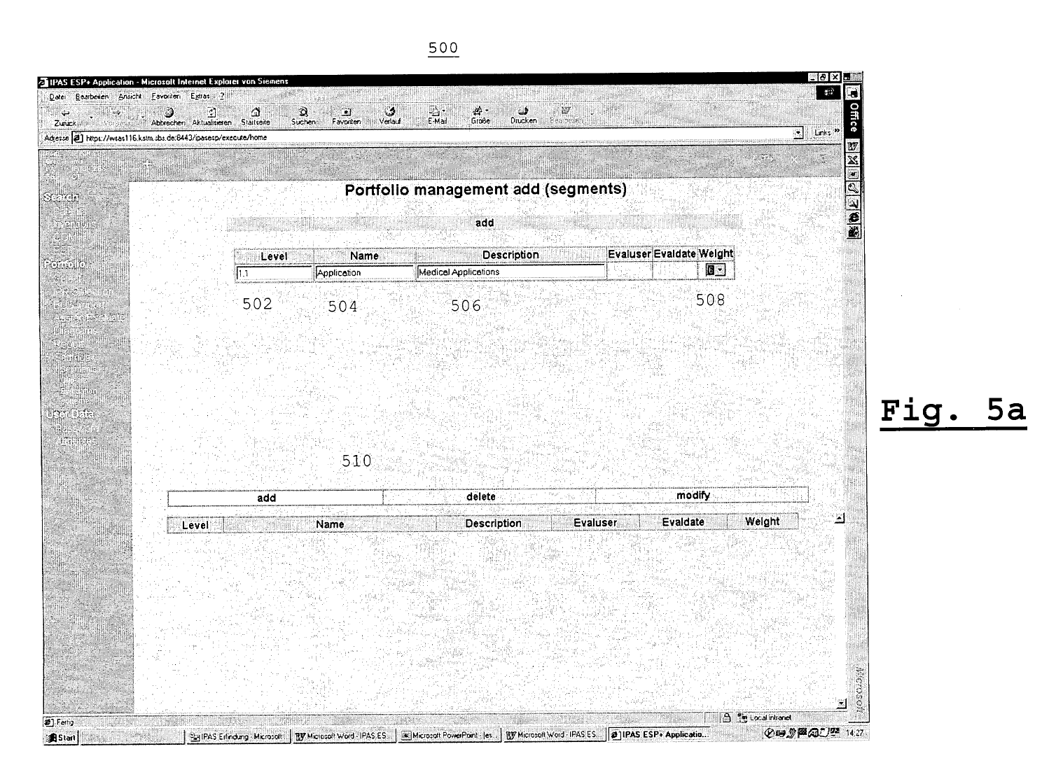

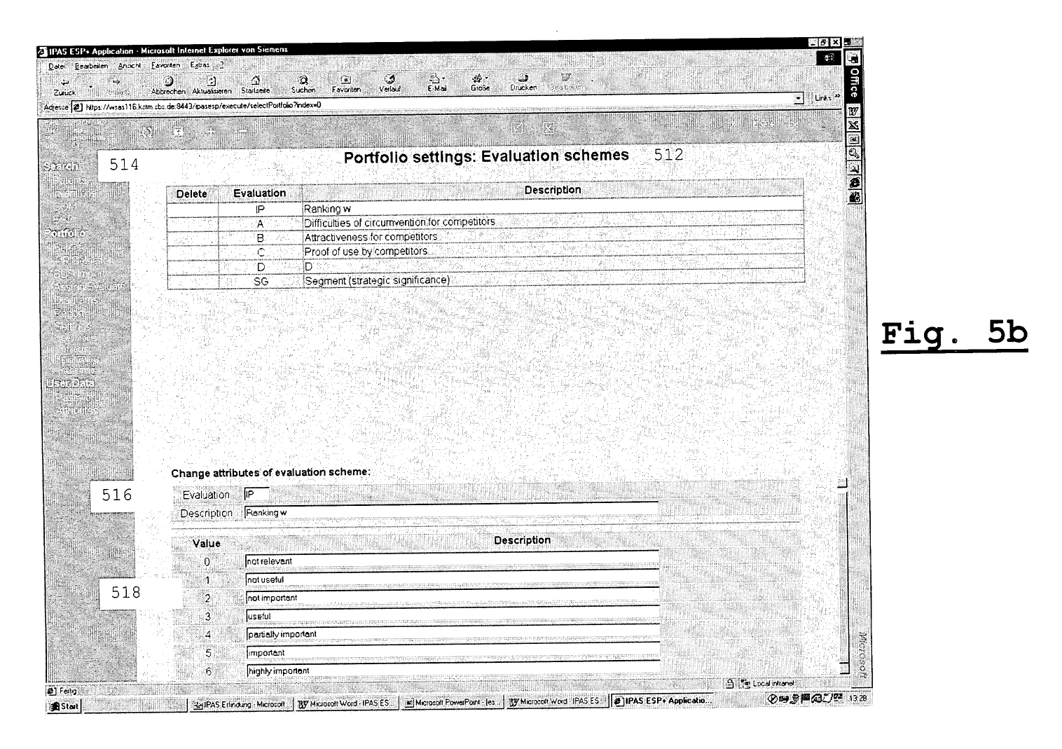

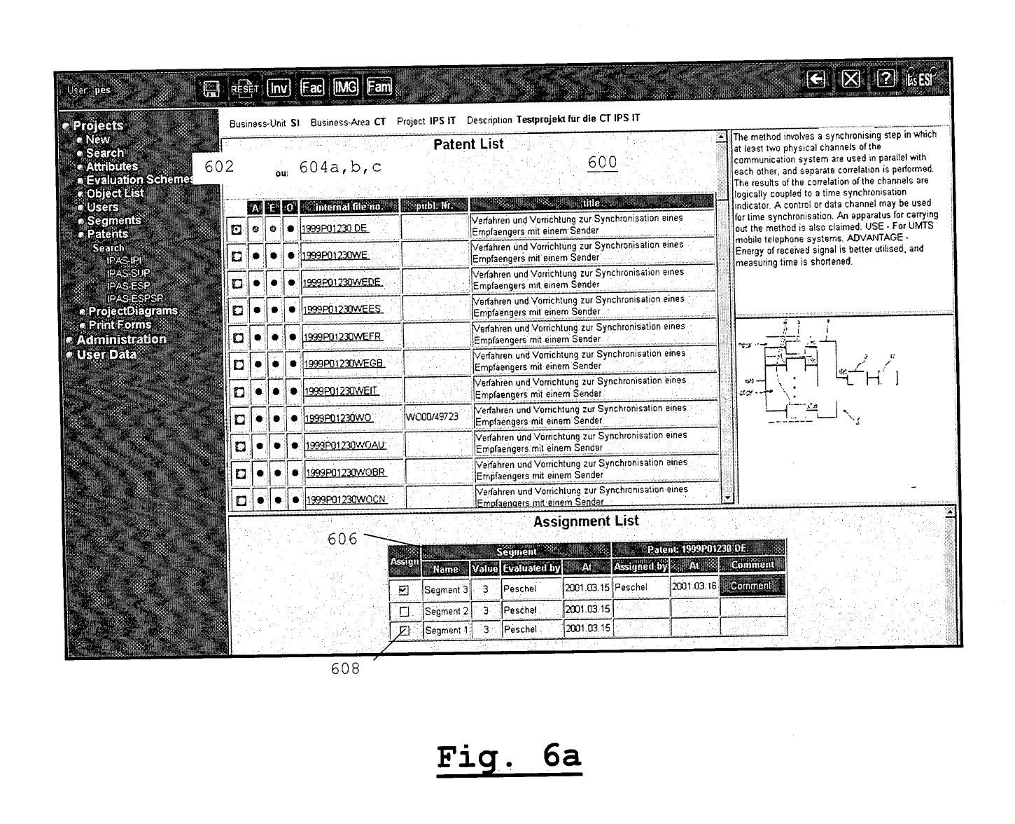

As shown in FIG. 5a, there is provided an add segments screen 500 that allows the user to set up segments and set values indicating a worth to the company for the segment. As shown, there is provided a level field 502 for inputting the level of the segment, which allows the user to set an hierarchical level, as will be described later. In the field 504, there is an naming field 504 for providing the input of the name of the segment. There is further a description field 506 that allows the user to give a meaningful definition of the segment. In addition, a weighting factor 508 is set. As shown, the weighting scale is a predetermined range. This is to provide for the standardization of weighting factors for all portfolios so that meaningful comparisons as between portfolios or among segments is achieved. Command buttons 510 are provided for adding, deleting or modifying the segments.

As mentioned, the invention provides the capability to create hierarchical levels of the segments. As shown in FIG. 4b, for example, the Application segment may be set to the highest level segment and named 1.1. Subsequent levels, such as for applications relating to the Abdomen, are set to a level 1.2. Sub levels of Abdomen applications 1.2.× are further provided. With such an arrangement, the invention has the advantage of allowing a user to create a portfolio with many layers and visualize the layers easily. In addition, the layers may be stored as corresponding files in an hierarchical file folder directory and easily manipulated, ie, cut and pasted. By the same token, sub-levels, as well as segments can easily be added or deleted simply by cutting and pasting file folders into the hierarchical file directory.

There is also a segment setting capability for the competitors portfolio. The same settings generally apply and will be deferred to the above description for setting the segments for entity portfolio. The settings are saved for the respective portfolio and stored in the database 116d for retrieval.

FIG. 5b shows the setting of the valuation scheme 512. Here, the user is provided with an evaluation type 514. In the exemplary screen shown in the figure, there is an evaluation (IP) having an overall ranking. Another ranking may be the difficulty of circumventing the patent (A) that indicates how difficult it is for a competitor to design around the patented invention as claims. Still another ranking is the attractiveness of the patent to competitors (B) that reflects the level of interest that a competitor in the field may have for the patent or related product. There is further provided a proof of use valuation (C) that indicates how easy it is to prove that a competitor is using the asset, ie, patent. There is also provided a strategic significance (SG) that indicates the intent of the company with the related product going forward. These factors are set by the coordinator, thus providing for the basic foundation of how the portfolio is to be evaluated.

Also in the figure is shown the selection of the scheme 516 and the setting and defining of values 518 (0 . . . 6). Here, the user is not setting the value itself, but rather defining the range of values and the respective meaning (not relevant to highly important, for example) for each value. With which, the coordinator is capable of setting forth concretely the evaluation scheme. Thereafter, the coordinator may allocate the task of evaluating the individual assets to the department or individual who understands the invention and relative market best. In this manner, there is provided a means by which the settings of the scheme and the evaluation of individual assets are accomplished by those who are best able to provide information. In our example, the business manager may be in the US and sets up the evaluation scheme and inventors residing in both the US and Germany telecommunications departments evaluate patents regarding inventions developed by their respective departments.

It shall be appreciated that the function of setting segments is not trivial to the invention. It allows the user to define the basis for an analysis. Moreover, it allows the portfolios to be searched according to meaningful search terms. In the aggregate, the users from the world-wide branches or business units collating the information and setting the segments and evaluation schemes according to their expertise provides a fidelity in portfolio management that has never before been achieved.

It will also be appreciated that the user, namely the coordinator in charge of administering the portfolio, has the ability to create and control the way in which the portfolio is analyzed through setting the segments and/or the scheme for evaluating the portfolio. This flexibility allows the user to custom tailor the analysis of the portfolio. In the foregoing example, the business manager can select certain segments as having a higher value to the company, for example according to her knowledge of the market. For that matter, she can set a valuation scheme that reflects the market worth of the patents, such as applicability to product, ease of proving a competitor's use or a competitor interest in the related product.

In order to maintain integrity to the portfolios, the invention provides for the administering of access rights and modification rights to a coordinator. As alluded to above, this appoints certain users, such as the business manager in our above example, the right to create segments and the evaluation scheme. With this arrangement, it is provided that the people who know the relevant market best are the ones who create the settings for the portfolio.

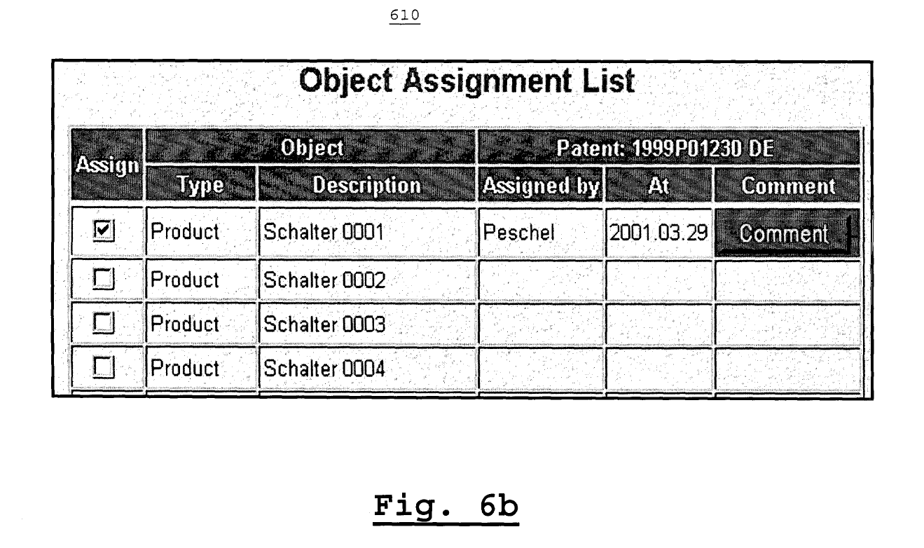

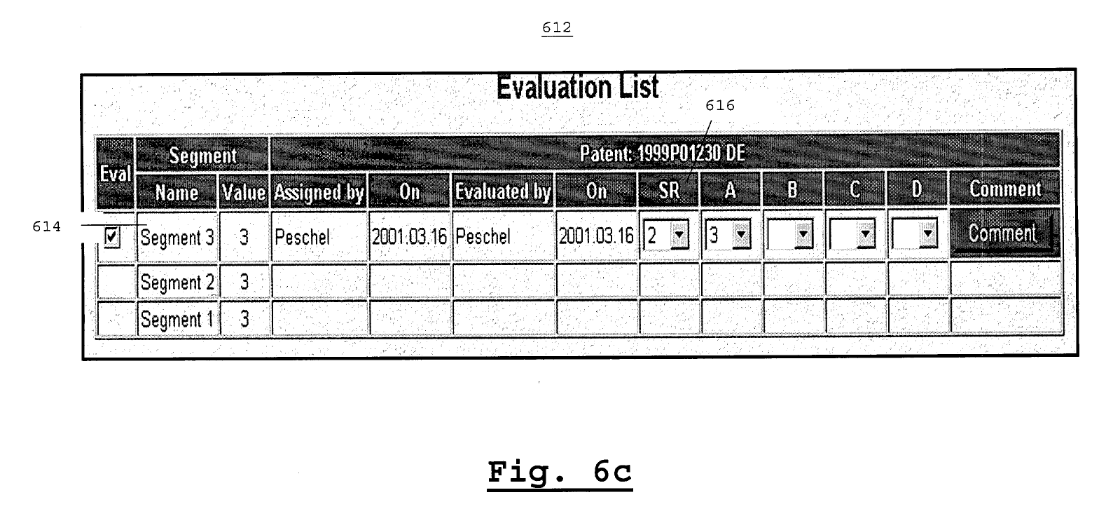

After the assets are assembled into a portfolio according to the search hit list functions described above, the assets may be assigned to a segment according to the assignment screen 600 shown in FIG. 6a. To facilitate comparison, each asset is assigned to a single segment, although it is certainly possible with the invention to assign multiple segments to an asset. In any event, there is shown the hit list screen from FIG. 3b. The user selects the asset using buttons 602 and then activates the assignment function by clicking on the A command button 604a.

Once activated, the assignment list 606 appears adjacent and in the same screen as the hit list. It shall be noted that this is not only convenient, but serves to assist the assignment of the assets by providing in a single screen, the asset data, such as abstract and figure and the assignment list. According to the invention, any part of the patent application is displayable in this screen, such as the patent claims. In any event, each segment is provided with an assignment selection box 608, that allows the user to assign a segment (1 . . . 3) to the asset. To assist the user in determining the correct segment to assign, there is provided segment information, including the name of the segment 610, the value of worth as set by the coordinator, the name of the coordinator who created the segment and the date of creation of the segment. With such information, the user is able to determine, for example, the importance of the segment from the value or the timeliness of the segment from the date of its creation. If the user has any questions, he can contact the coordinator indicated by the assignment list. When the asset is assigned to the segment, the assignee name is stored and displayed in the assignment list and the date in order to preserve a record of the users involved in the assignment in order later review the decision of assignment. The assignment of assets of the competitor is also provided using the same scheme.

As shown in FIG. 6b, there is shown an object assignment list 610. Similar to the assignment list for the entity portfolio, the list shown in FIG. 6b allows the user to assign the assets to a segment created by the coordinator. In addition, and as shown in FIG. 6b, there is provided the ability to assign the assets to objects such as products. As shown, a description of the product, the responsible user who sets the assignment and the date are provided. It shall be appreciated that assignable objects is advantageous because the user is given the capability to compare assets, such as patents, to products. These may be the patents of the entity, which illustrates the protection of a patent portfolio, for example. On the other hand, the objects may be that of the competitor, which illustrates the coverage of the patent portfolio of the competitor.

When the user selects the evaluation button (604b, FIG. 6a), the evaluation list 612 in FIG. 6c appears in place of the assignment list. As the patent application 1999P01230 was selected in FIG. 6a, the evaluation list that is instantiated by the invention provides evaluation on this application. As indicated, this application has been assigned to the segment 3 as referenced generally by 614, wherein the segment name and other information already described are provided. There is provided valuation boxes 616 that allow the user to set a value for each of the evaluation criteria set forth by the coordinator. In the exemplary figure shown, there is provided the ranking of the asset itself (SR in the Figure). For this, the coordinator had predetermined definitions for the values as shown in FIG. 5b. When the user selects SR as the value 2, for example, the value “not important” is set as the ranking for this asset in the portfolio. In the case that the difficulty to circumvent the patent (A) is set to the value 3, the value may indicate that the patent is moderately easy to design around. Of course, this would depend on the definitions predetermined by the coordinator. The other evaluation criteria may also be set accordingly by selecting one of the corresponding values provided by the evaluation list 612.

It will be appreciated that evaluating the assets in this manner is advantageous. It allows the coordinator, such as a business manager, to predetermine the segments, according to market segments for example. Further, the coordinator sets the evaluation scheme, ie, the criteria and values therefor. Then, the sub-entities from around the world, that is, the people who have the first hand knowledge of the asset to evaluate the assets. This not only is a great conservation of work for the coordinator, it provides the best possible evaluation of the portfolio. The people who know the best about the asset are the same people who provide the evaluation. Combined, the efforts of all the constituent parts of the entity around the globe make for a portfolio that more precisely indicates the true nature of the market than ever has been possible before. The data is then stored in the database 116d for reporting and, in addition, future updating and modification.

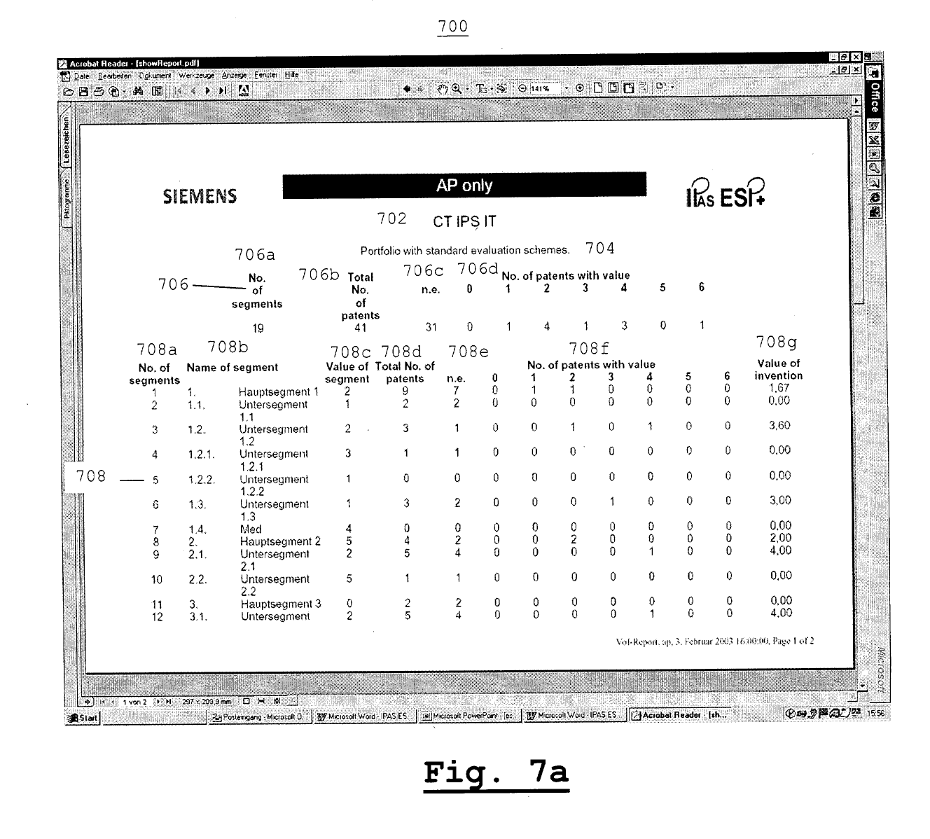

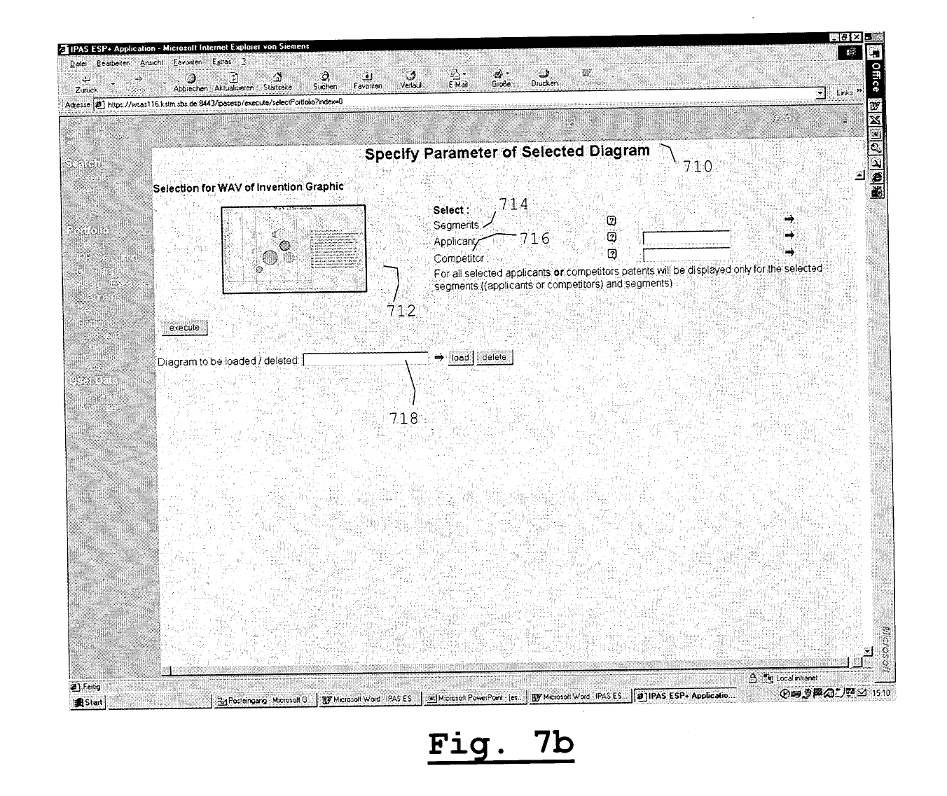

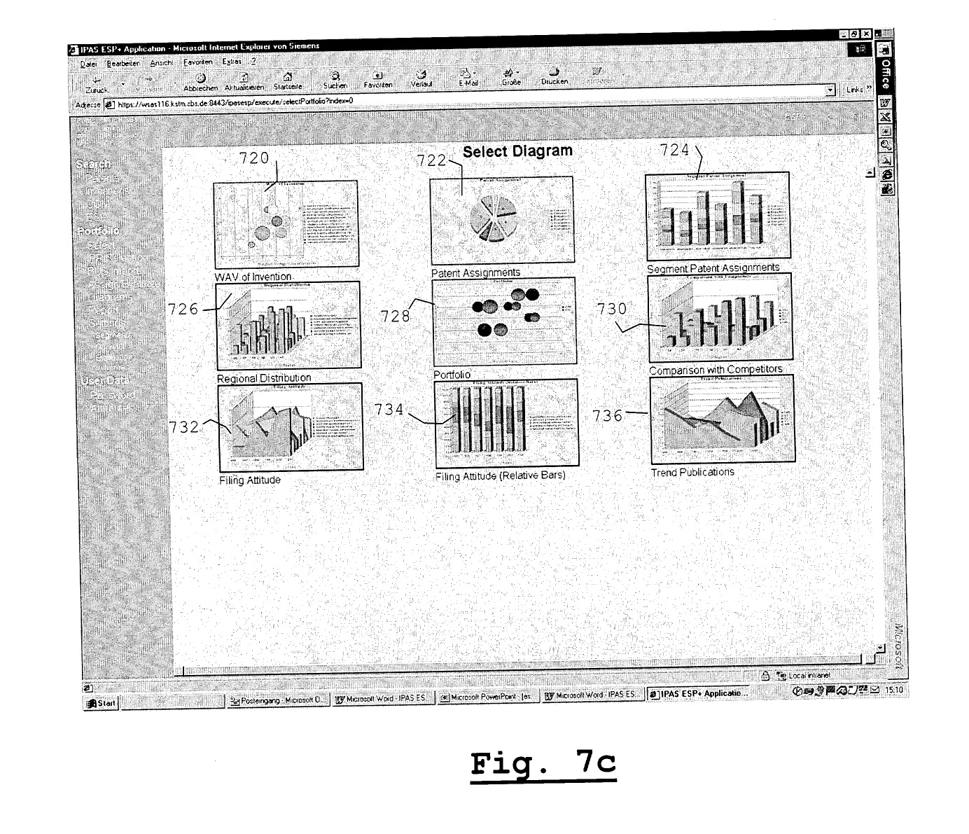

Now that the evaluation of the assets have now been described, the analysis thereof will be discussed with reference to FIGS. 7a-7c. In FIG. 7a, there is shown a report 700 of the results of the assignment and evaluation for a particular portfolio for the evaluation criteria A, which relates to the difficulty to circumvent the patents. There is the business unit 702 that concerns the portfolio stated in the report and a title 704 provided, which may be a default title as shown for the standard evaluation. More concretely, the invention reports an overview 706 of the evaluation comprising general information therefor. The number of segments 706a in the evaluation is reported along with the total number of patents 706b. Thus, in the invention there is provided in one convenient report an overview of the distribution of the evaluations within the whole portfolio.

From this information, the user obtains an understanding of the size of the portfolio and whether there is enough information for a meaningful report. There is further provided the number of patents 706c not evaluated, or still to-be-evaluated, which indicates the completeness of the report or the difficulty in evaluating the assets for the given segments. There is provided in the example the valuation spread 706d of the patents for the evaluation A, wherein the number of patents having a particular value in the evaluation criteria A is shown. Here, for example, the business manager can see at a glance, that the evaluated patents fall mostly in either value 2 or 4, indicating that the patents are mostly easy to circumvent or moderately easy. Of course, the business manager can also see that the majority of patents are not evaluated.

There is also provided a more detailed section 708 which provides the user with a more detailed look at the portfolio. 708a provides a list of the segments by number and 708b provides the user with the name of the segment for ease of understanding. 708c shows a corresponding value to the segment and 608d indicates a corresponding total number of patents assigned for that segment. 708e indicates the number of patents not evaluated for the respective segment. 708f shows the breakdown of the value of each patent according to every segment shown. 708g is a value of the inventions of the segment, which may be a weighted function depending on the value spread of patents in a particular segment.

It will be appreciated that with this report, the user can quickly scan and come to a overall understanding of the portfolio. In the example shown, the results show that the most important segment 8 and 10 relate to segment 2, hardware for medical devices and gradient systems in particular (FIG. 4b). Further, the user can see in the example that the most important segments have patents that are more easily circumvented. This suggests to the manager that more effort needs to be placed on developing patents that are harder to design around. Or, it may suggest to the manager that the inventions in the most important segments are difficult to protect, which may indicate that the manager should not allocate as much budget to the filing of patents in this area. It would also appear that the strongest patents are found in segment 3, relating to medical applications for angio/cardio, for example. Of course, the report shows that the manager should poll the employees to finish the evaluation so that a proper report can be obtained.

Reports are useful, but what is further provided by the invention are tools for analyzing the portfolio. For this, the invention provides various graphical tools for graphically demonstrating various aspects of the portfolio as shown in FIGS. 7b and 7c. In general, the invention provides a parameter screen 710 for each graphic tool that allows the user to set up the information for graphic display. Within this screen, there is depicted an icon 712 representing the selected graphical tool. The user is then prompted to select the segments to form the part of the analysis as generally indicated by 714. In addition, the user can select the Applicant and/or any competitor.

As mentioned, there may be several business units in the entity and, correspondingly, may be more than one Applicant. With these parameters, the invention compiles the assets from the selected segments of the presently selected portfolio and generates a graphic for the applicant according to the algorithm followed by the graphic tool selected. Further, when a competitor is selected the invention provides the graphic of the portfolio for the Applicant in comparison with that of the competitor. Of course, the competitor portfolio may be viewed alone. The results of which may be stored according to store and retrieve function 718. Similarly, graphics can be uploaded using the same function.

As shown in FIG. 7c, there is provided the usr-selectable graphical icons 720-736, wherein upon selection of a graphic icon, the user is forwarded to the respective graphic engine. The graphic icon 720 links the user to the weighted average value (WAV) graphic engine that provides at a glance the worth of the selected portfolio. The invention assembles the assets for each segment and allocates a different colored balloon therefor that is sized according to the number of assets in the particular segment. The invention then calculates the strategic significance for all the assets in a particular segment by averaging the strategic significance (SG) valuation of all the assets in the segment and positions each balloon along the y-axis according to the level of strategic significance for the segment. The invention then calculates a weighted average for each segment. In one aspect, this is done by weighting each of the valuation criteria and averaging the weighted sum. The invention provides the ability of the user to set the weights for each criteria, thus allowing the user to place extra emphasis on selected criteria in order to provide a custom tailored graphic.

According to the exemplified WAV graphic engine, the larger the balloon, the greater the number of assets are in the respective segment. Balloons that are highest in the diagram have the most important strategic significance to the entity. Whilst, balloons that are situated most rightward in the diagram have the highest weighted value to the entity. Thus, according to the specific diagram shown in FIG. 7c, the business manager notices immediately that the largest segment of assets in the second to least important in value to the company and about tied for second to last in strategic value. In other words, there is a large segment of assets in the example entity that are off the strategic path of the company and are relatively not as valuable. This suggests to the manager that less resources should be focussed in the future for these assets and more place in the balloons more situated to the upper right in the diagram.

The graphic icon 722 representing a patent assignments graphic engine provides the user at an instant the distribution of the value of the assets for one or more segments. It shows how many assets with the same value are in the portfolio. As shown in the Figure, the assets are grouped as wedges of a pie chart. In the example shown, there are 9 assets with a value of 3, 6 assets with a value of 4, etc. With this graphic, the manager in our example can determine instantly that the majority of patents centers around the 3 value, which in our example is somewhat important. It would be a goal for the manager, for example, to bring the majority of patents in the range of a value of 4 for the future.

724 depicts the graphic icon for segment patent analysis. Similar to the previous graphic engine, this provides a view of the number of assets in each segment with the same value. In this graphic, there is provided a plurality of segments side-by-side for ease of comparison. Each segment is set in the form of a 3-dimensional tower, each bar divided into different colored bars. Within each of the segment towers, the different colored bars each represent a different grouping of assets of that segment having the same value. In our example, the manager can clearly see which segments are the largest and amongst the segments those that have a content rich with important patents. Further, the invention assembles the values in each tower successively such that the colors of the bars in adjacent towers are sufficiently aligned so that the user can easily compare the segments.

The graphic icon 726 represents the regional distribution graphic engine. This graphic shows the assets according to the distribution of countries in which the assets apply. In patents, for example, the graphic engine organizes the patents according to the respective country in which the asset is pursued or in force for each segment. As show in the figure, for example, the countries are arranged along the x-axis. The segments are arranged along the z-axis. The number of assets in each segment are arranged along the y-axis. At a glance, the manager in our example can determine in which of the countries are most of the patents being pursued or in force. In a global company, such information is highly relevant to business discussions for matching targeted markets with patent coverage.

Another graphic icon 728 links the user to a portfolio comparison graphic engine. Here, the invention assembles the segments into balloons as arranges them according to a weighted average, similar to the procedure of the WAV graphic engine already discussed. In this case, the invention provides in one view one or more portfolios. It may be provided, for example, the entity's portfolio and a competitor's portfolio. As shown in the figure, the portfolios are placed side-by-side for ease of comparison. In addition, the colors for similar segments in each portfolio are set by the invention to be the same in order to provide at an instant the relative positioning of respective segments between the two portfolios. It shall be appreciated, for example, that the manager can in an instant compare the relative segments of her company to that of the competitor and see where the focus of her company lies and where the competitor is heading. With this information, the manager can come to understand competitive trends and react accordingly.

In another comparative analysis to competitors, there is provided a graphic engine linked to a graphic icon 730. Here, the invention further organizes the portfolios of both the entity, or two competitors for that matter, according to the country in which the assets are relevant. Thus, as shown, the countries are formed along the x-axis. The number of patents in a segment are formed along the y-axis. And, the different types of segments owing to the competitor are assigned along the z-axis. In one aspect, the invention adds the entity segments to each tower such that the entity segments lie on top of (or under) the respective competitor segments for ease of comparison. With such a graphic, the manager of our example can immediately see in which countries his company is better protected and where the competitor is ahead in protection over the company. Further, the graphic shows in which technical areas, the company has an advantage over the competitor and vice versa.

The next graphic engines relate more toward the analysis of asset handling and management within the entity. This allows the manager to better administrate the handling of the assets internal to the company. For the graphic icon 732, for example, there is provided a link to a filing attitude graphic engine. For each segment in the example, the graphic engine tracks the activity over a period of time. The activity may be any time parameter, such as filing date of the asset, publication or the date the asset is granted or in-force. The time period may even be the date which the asset is abandoned. Thus, from year to year (or any time increment set), the user is able to see how much activity is occurring for every segment. In our example, the manager can determine at a glance which segments are active. The graphic is provided as an integral of a bar chart, wherein the slopes define trends of activity. The rate of change indicates the speed at which activity is changing for a segment, or technical area for example. Steep slopes moving upward indicate fast up-ramping of activity in an area, perhaps in response to radical market changes or change of direction of the company. Slight grades indicate stable areas of asset acquisition.

The next graphic icon 734 illustrates the filing attitude in terms of a bar chart. Here, the segments are formed in a tower for each year, with each segment comprising a colored bar within that year. With this chart, the user can easily determine the share of time expenditure required in each year allocated amongst the different segments. This allows the manager in our example to monitor and regulate time management of the employees responsible for acquiring or handling the assets. Perhaps, the manager determines that the employees are focussing too much in certain areas and not spreading the effort consistently over all areas.

Another graphic icon 736 provides a link to a trend publications graphic engine. Here, the invention provides a view on the competitors' asset acquisition or abandonment. The same time periods as with the graphic of 732 or 734 are available. In this graphic engine, there is providing a mapping over a period of time of the activities of the competitor per segment or object. Thus, when the objects represent objects, the manager in our example can quickly see the trend of releasing products in certain technical areas and the trend of discontinuing the products. In terms of intellectual property rights, the chart shows the trend of the competitor acquiring patents, etc., for a certain technical field. With this information, the manager in our example can at a glance see what directions the competitor is proceeding with her assets and can make predictions on the technical direction that the competitor is heading. In response, the manager can affect the direct of her company or asset coverage to counter or out-pace the competitor.

Further graphic engines may be added to the invention. In addition, bells and whistles such as rotation and elevation of the produced graphics are available.

The invention has within its meaning the applicability to internal administration of the entity to allow the entity to self-administrate its assets, rather than hiring an outside firm to perform the task. As pointed out, the internal entity has at its disposal information that is not available to the public, ie, to the firm. It is also not possible for outside firms to integrate all the information from all of the constituents of the entity from all over the globe. The invention in terms of intellectual property has in mind specifically the administration of intellectual property assets by an internal patent department. In our example, the manager is a patent manager and the employees are patent professionals or attorneys. It will be appreciated therefore that the invention enables the patent manager to monitor the activities of the entity and direct the professionals to perform activities in particular areas dependent on the manager's evaluation of the entity and/or competitors using the tools of the present invention.

In addition, it shall be appreciated that the invention, in one aspect, is integrated at the entity end, i.e. is client based. For example, and as already explained, the invention is integrated with the local network of the client, such as the internal intranet. It shall be appreciated, therefore, that the invention works within the sphere of confidentiality of the entity. For that matter, there is provided user data (302, FIG. 3a), such as password and access rights that are stored in the database 116a (FIG. 1). With which the invention allocates access rights to each user dependent on the user status and on the contractual relationship between the user and the portfolio of the entity. Thus, the Chinese venture capital group in our earlier example is given access only to the portfolio covered under the joint venture agreement such that other confidential data to which the Chinese firm has no legal right to is maintained confidential.

Export

It shall be appreciated that the invention provides a network of information. In particular regards to competitor data, the invention is particularly advantageous. Companies tend to keep business policies secret and the publication of competitor data is not always forthcoming to the public. The invention, by contrast, is a global network of users inputting data to the system. While this seems apparent, it has never before been the case that the fidelity of data regarding a competitor can be collated and developed in one central location. In our example, the Chinese firm may have local knowledge of the competitors through, for example, local trade publications or trade shows. This information is difficult, if not impossible, to come by in Germany given the geographic an language barriers. The German constituent, on the other hand, understands the nature of the European branches of the competitor and inputs data regarding that area of the market. Combined, the overall portfolio on a competitor provided has never before been possible.

As earlier mentioned, the invention also has provides a portal. What is novel about the portal is that it not only provides a convenient interface through which the users input and manage the data, but it also provides a predetermined mode of operation dependent on the status, ie, legal relationship or job description, of the user within the entity. Managers are provided a portal that views all employee data whom are under their supervision. Employees are provided a portal that provides them with information on assets that they have created and to input data regarding the assets into the afore-mentioned portfolio management device. Professionals that are responsible for the management and handling of the assets are provided a portal allowing them to report on and provide consultation to the managers and employees of the entity. The Portal, further, serves to connect the users. It provides the doorway into a forum where users share improve data regarding assets.

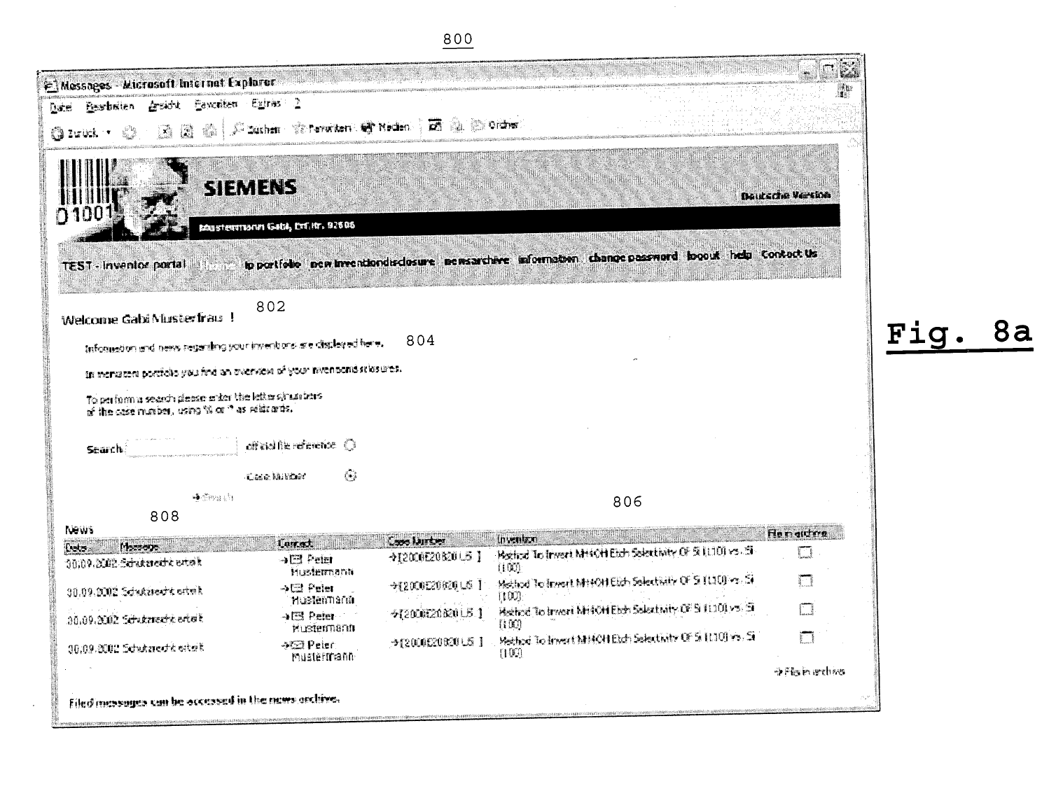

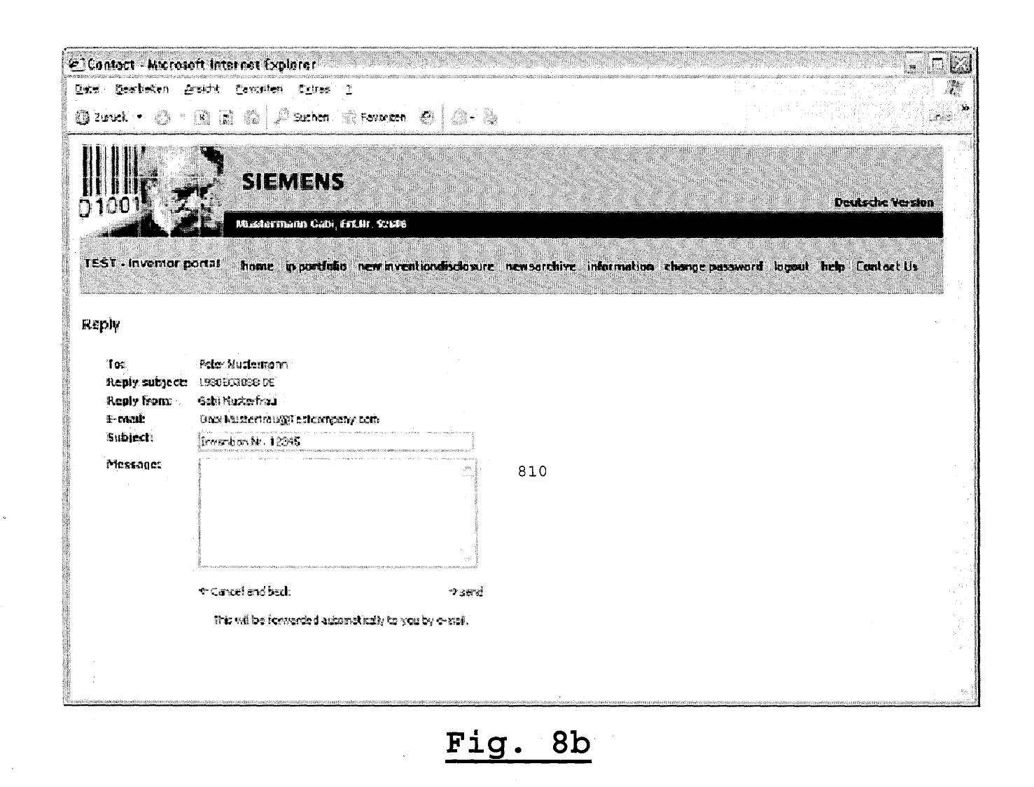

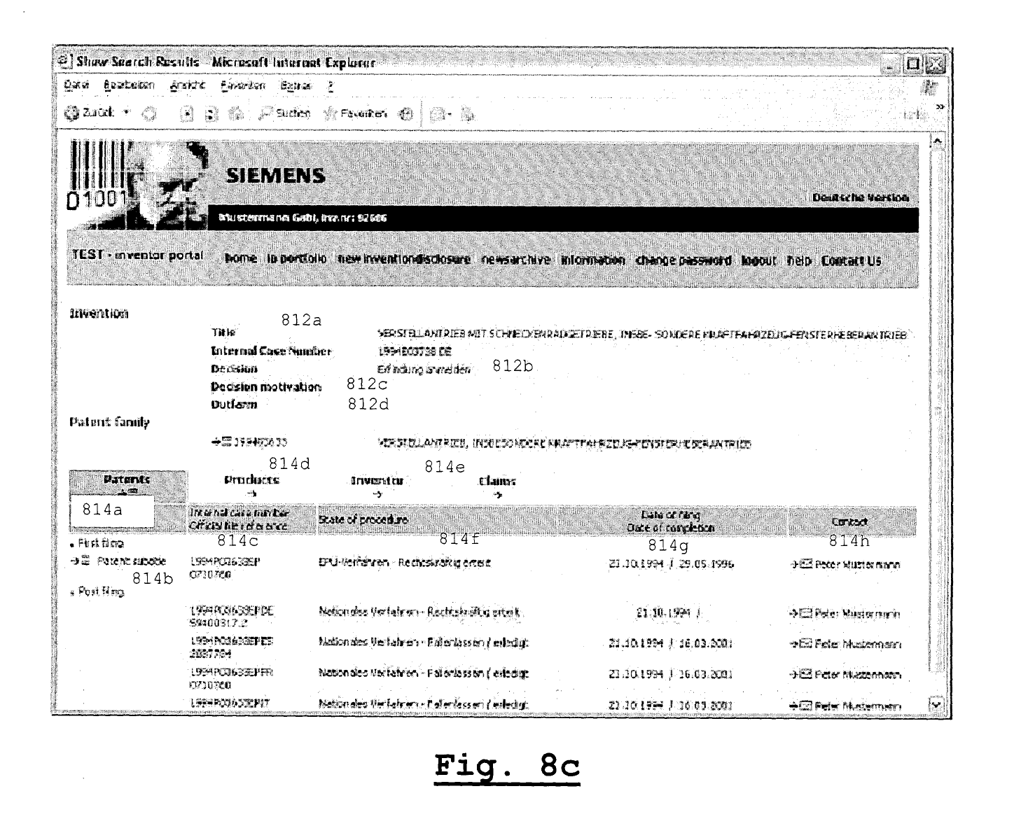

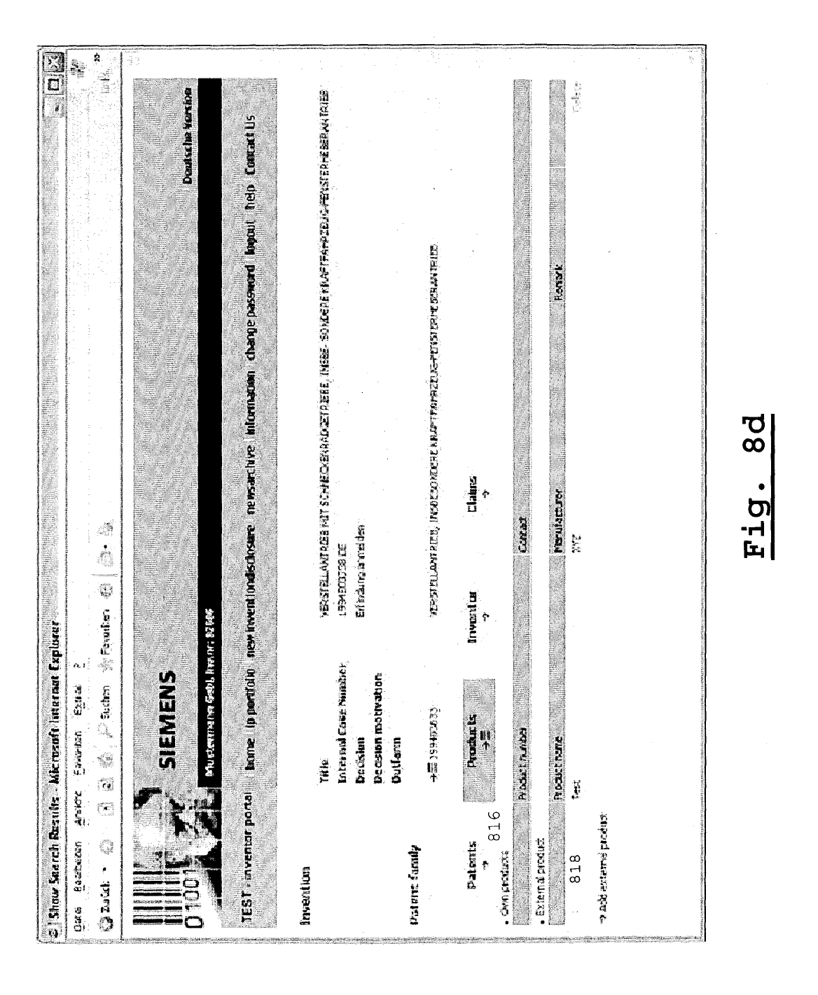

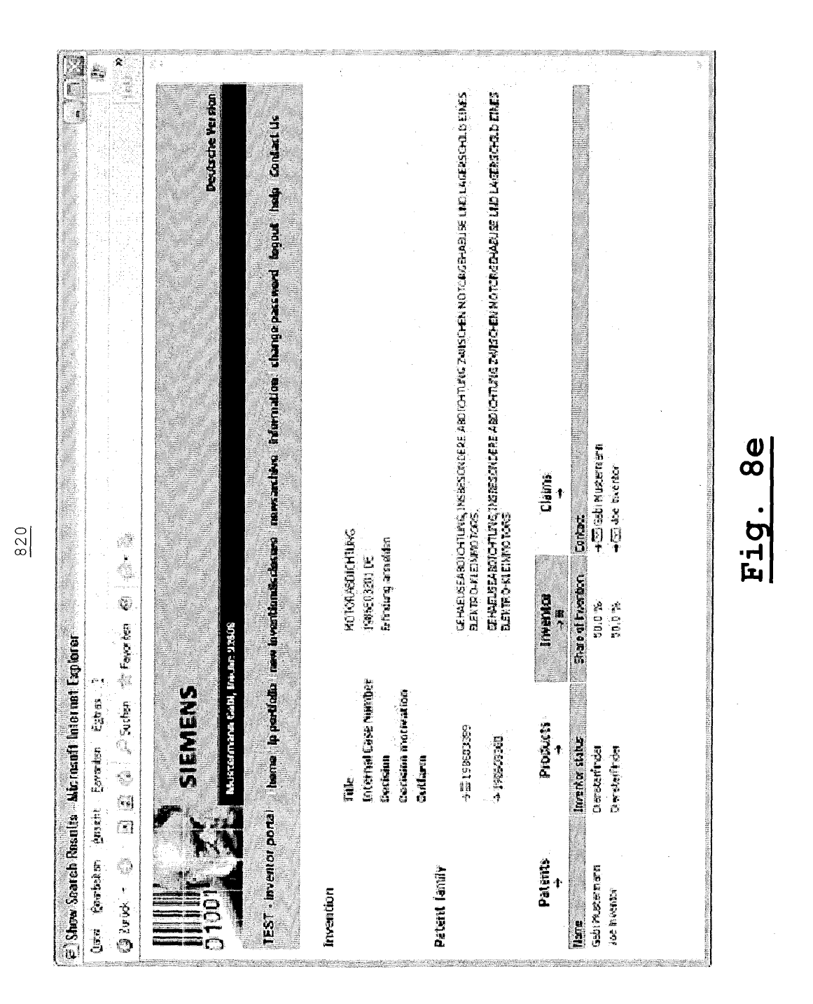

Now with respect to FIG. 8a, there is shown the inventive portal 800. The portal resides at the client side 118 (FIG. 1) which uploads and downloads data through the network, ie, Internet, to the portfolio management server. The portal is preferably a true portal in that it has the same layout and color for each screen. As opposed to a web page that links to different pages, a portal updates the tables within the interface. As shown, the portal is configured upon instantiation to greet the employee 802. Further, the portal uploads information regarding the employee 804. In the preferred embodiment, the portal loads the data from the local intranet to which the employees portal is already connected. It shall be appreciated that this is not possible heretofore as the previous devices were not linked directly with access to the network of the entity, ie, company.

In any event, the employee data is used to determine the assets that the employee is involved with. For this, there is provided a hit list of assets 806 regarding the employee. This information is provided by the search, already described, with the employee's name searched as the criteria. The invention further provides in the hit list assets that require management. In the example, the hit list is compiled from patent applications to which the employee is an inventor and is involved in making a decision regarding the development of the asset into a patent.

Often times, companies prepare what is known as invention disclosures that disclose the fundamentals of an invention and the worth of the invention to the company. Other information, such as date of public release and product relevance are provided in the invention disclosure. It is a problem that the inventors often do not have the time to provide much of the information required in the invention disclosure and the internal patent department experiences delays in filing applications. In addition, the inventors often complain that they are not kept informed about the status of the invention disclosure, the development of the subsequent patent application and the grant of the patent. Business managers have traditionally complained that they spend money on patents that they have no idea what is developed or abandoned. In some jurisdictions, such as Germany, that require inventor compensation by law, the information is very important that the inventor be informed of her rights and is given sufficient notice to either be compensated or abandon the invention to the company. By contrast, the company is required by law to either provide adequate notice to the inventor or waive rights to the invention.

The portal of the present invention provides a convenient method for handling of invention disclosures. It provides a unique way of prompting and reminding the inventors to complete invention disclosures. At the same time, the portal provides a systematic and reportable approach to compensating inventors and recording notice of the invention to the inventor. It further provides a manner in which the inventors are capable of monitoring the development of the patent application. It provides a transparency by which management is satisfied with the progress of the development of the patents.

Another problem, already alluded to above, is that it is often the case that a global company is not capable of determining the development of the assets in branch business units. Geographic and language barriers prevent the managers of the central company from easily obtaining information on the development of assets. With the invention, there is provided a portal in the language of the user such that all the users world wide input and receive information in their native language. With the global network of the world wide web, the managers from all over the world can access and be informed about the progress of their assets. For this there is provided a message hit list 808, which lists the messages on the portal for the respective employee.

There is shown in FIG. 8b the portal 800 with a messaging dialog box 810. In the dialog box 810, the portal uploads the messages from the portfolio server (FIG. 1) and displays them here. The invention displays the information, which may be attached in a header of the message, of the sender, date & time, email address and subject, etc.

It shall be appreciated that messages are sent through the corporate Intranet are protected from corporate spying or illegal interception. It is a problem in these days that corporations are using the Internet to spy on their competitors. It is the case that corporate deals have mushroomed because competitor spying tipped off the competitor to the details of the pending deal. Similar to corporate deals, the assets or acquisition thereof indicates the direction of the company and is sensitive information. It shall be appreciated, therefor, that the invention provides a more secure approach to sending confidential information regarding assets through the network of the entity.

Now with reference to FIG. 8c, there is shown the inventor mode of the portal. In this mode, the invention automatically displays, in a predetermined format, the patent applications to which the employee is an inventor. In the figure, the invention main information 812 is shown, including the title and internal reference number a. In addition to identifying information, there is displayed the decision(s) regarding the invention. In many company's a steering patent committee sits in each business unit and is composed of managers from central business, technology groups, sales, etc., who decide how to spend asset budget. Typically, each invention is decided whether to be turned into an asset, ie, patent application. Further, the total budget for each asset is decided and timing is decided based on predictions on the market or product release dates. Sometimes, the inventor himself is not part of the decision meeting. The portal thus displays for the inventor the decision. In addition, the portal provides the decision motivation, that is, the grounds on which the invention was accepted for patenting or denied. In addition, there is displayed by the invention the outside firm that is responsible for handling the case, if any.

Typically, a single asset does not cover a tangible item, such as a product. In patents, such as standards, there are typically a family of patents and applications that cover various features of the product. Thus, companies rarely think of patents individually, but prefer to discuss families of patents. They want to know if their products are covered, and are not so interested that they have a patent on, for example, the port in the rear of the product. The portal of the invention provides therefor the patent family 814. For ease of reference, the invention provides the first filing 814a first on the hit list and then the related filings, such as related patent applications in other countries 814b. As shown, for each patent or application, there is shown the identifying information 814c, the filing date and a contact person. In addition, the invention displays the product to which the patent relates 814d and the inventor or inventors 814e.

Now it shall be appreciated that the actual status of the asset has not been heretofore reported to the entity in a consistent and reliable manner. Nor, has it been so conveniently displayed in a single portal with other relevant information in this predetermined format. As shown in the figure, the invention provides the present status of the asset. It shall also be noticed that the status is reported in all the jurisdictions in which the asset relates. Thus, providing a truly global view on the portfolio. It shall also be appreciated that the statuses include both statuses of the related governmental agency as well as the status imposed by the entity. In our patent example, there is provided the status, for example, to abandon the case. While this is not reported to the patent office, the status is shown and displayed here. Thus, there is provided a true status of the invention according to the owner of the asset and not necessarily that which is publicly known.

Other information that is displayed, which resident only to the entity, is administration data. There is shown the date of completion of work relating to the asset. In patents, this could be the date the invention disclosure is completed as a patent application. Such information is important for reporting as well as managing how fast inventions are turned around by the patent department or outside counsel. There is also provided the contact person for each asset. In the invention, the contact person is linked through the Intranet to the portal and the user need only click on the contact person to obtain further correspondence details or to instantiate a message or email to that person. In patents, for example, the contact person is the respective patent professional within the company who prepares the patent application and files the same with the country jurisdictions.

In a product mode of the invention, there is provided a view of the products 816 of the entity sorted according to the database in FIG. 1. The products in the example are shown related to a particular asset, here a patent. In addition, the invention provides, adjacent thereto, the related competitor product. In another mode of the portal of the invention, there is provided a manager mode 820, which shows all the inventions of the employees in his department. This is shown in FIG. 8e. The manager can, thus, select any of the inventors by clicking on the respective name and the manager is directed to the respective invention as shown in the previous figure.

The invention, thus, provides a system, method and apparatus for portfolio creation and management of assets and for reporting and analyzing the portfolios. The invention provides asset analysis for both the entity and the competitor and allows for analysis and comparison there-between. The invention provides a world wide network of information that employs all of the constituent part of a global business and places, in the hands of the people who know the best, the responsibility to report and update the portfolio databases. The invention, further, provides a portal for interfacing the users to the portfolios with which the predetermined format concatenates the portfolio data and presents it in a convenient and centralized format according to the different types of employees of the entity. With which, the invention provides a more secure means of interacting and developing assets through the use of connection to the local Intranet of the entity. While the invention has been described primarily with respect to patents, the invention covers all types of intellectual property and, for that matter, is relevant and covers any type of asset. The invention has been described in sufficient detail in terms of a system architecture and one skilled in the art will know how to implement the invention without undue experimentation.

We claim:

1. A portal apparatus residing on a client side of a network that interfaces with a portfolio creation and management apparatus residing on a server side that creates and manages intellectual property assets of a global entity having sub-entities located in various localities around the world, said sub-entities having a legal relationship to the entity, by contract or by law of an internationally recognized jurisdiction, the apparatus comprising:
network connection to a sub-entity of the global entity residing in more than one jurisdiction;
a graphical user interface that provides information relating to an intellectual property asset dependent on the type of employee accessing the graphical user interface from the sub-entity; and
wherein the graphical user interface provides at least business administration information regarding a business decision of how the intellectual property asset is to be managed.

2. The apparatus of claim 1, wherein the network connection links worldwide sub-entities and provides communication between the sub-entities regarding at least one of the intellectual property assets.

3. The apparatus of claim 1, wherein the graphic user interface is a portal that comprises a common look and feel throughout presentation of the information relating to the intellectual property asset.

4. The apparatus of claim 1, further comprising an inventor mode, wherein the graphic user interface provides information relevant to inventorship including at least an internal status of an application for the invention based on internal decisions of the global entity.

5. The apparatus of claim 4, wherein the graphic user interface provides information relating to an invention disclosure of the intellectual property asset.

6. The apparatus of claim 5, wherein the graphic user interface provides entry by the inventor to improve a content of the invention disclosure.

7. The apparatus of claim 1, further comprising a manager mode, wherein the graphic user interface provides information relevant to employees within a department of the sub-entity a manager is responsible for.

8. The apparatus of claim 7, wherein the graphical user interface presents information relating to intellectual property assets invented by the inventors.

9. The apparatus of claim 7, wherein the graphical user interface provides for systematic remuneration procedures and notification to inventors of the intellectual property asset.

10. The apparatus of claim 1, wherein the graphical user interface presents patent families relating to an intellectual property asset.

11. The apparatus of claim 1, wherein the graphical user interface presents product data relating to the intellectual property assets.

12. The apparatus of claim 11, wherein the graphical user interface presents competitor products relating to the intellectual property assets.

13. A method for interfacing a portfolio creation and management apparatus residing on a server side that creates and manages intellectual property assets of a global entity having sub-entities located in various localities around the world, said sub-entities having a legal relationship to the entity, by contract or by law of an internationally recognized jurisdiction, the method comprising the steps of:
providing information relating to an intellectual property asset dependent on the type of employee accessing the graphical user interface from the sub-entity; and
providing at least business administration information regarding a business decision of how the intellectual property asset is to be managed.

14. The method of claim 13, further comprising the steps of linking worldwide sub-entities and providing communication between the sub-entities regarding at least one of the intellectual property assets.

15. The method of claim 13, further comprising the step of providing information relevant to inventorship including at least an internal status of an application for the invention based on internal decisions of the global entity.

16. The method of claim 13, further comprising the step of improving by the inventor a content of the intellectual property asset.

17. The method of claim 13, further comprising the step of providing information relevant to employees within a department of the sub-entity a manager is responsible for.

18. The method of claim 13, further comprising the step of providing systematic remuneration procedures and notification to inventors of the intellectual property asset.

19. The method of claim 13, further comprising the step of presenting product data relating to the intellectual property assets.

20. The method of claim 13, further comprising the step of presenting competitor products relating to the intellectual property assets.
